(19) United States
(12) Patent Application Publication
(10) Pub. No.: US 2015/0069290 A1
(43) Pub. Date: Mar. 12, 2015

(54) POLYCARBONATE BASED DUCTILE THERMALLY CONDUCTIVE POLYMER COMPOSITIONS AND USES

(71) Applicant: SABIC Innovative Plastics IP B.V., Bergen op Zoom (NL)

(72) Inventors: Mingcheng Guo, Shanghai (CN); Yaqin Zhang, Shanghai (CN); Yun Zheng, Shanghai (CN)

(21) Appl. No.: 14/023,320

(22) Filed: Sep. 10, 2013

(51) Int. Cl. C09K 5/14; B29C 47/00

(52) U.S. Cl. CPC C09K 5/14; B29C 47/0004; B29K 2069/00
USPC 252/75; 264/211

(57) ABSTRACT

Disclosed herein are thermally conductive blended polycarbonate compositions with improved thermal conductivity and mechanical performance properties. The resulting compositions, comprising one or more polycarbonate polymers and one or more thermally conductive fillers, can be used in the manufacture of articles requiring thermally conductive materials with improved mechanical properties such as electronic devices. This abstract is intended as a scanning tool for purposes of searching in the particular art and is not intended to be limiting of the present invention.

### FIELD OF INVENTION

The present invention relates to blended thermoplastic polymer compositions comprising one or more polycarbonate polymers and one or more thermally conductive fillers, wherein the blended polymer composition have both excellent thermal conductivity and mechanical performance properties.

### BACKGROUND OF THE INVENTION

Decreasing the dimensions and weight of components as well as increasing performance in portable electronics is a key market demand. However, the reduction in size of electronic devices results in greater heat retention which can degrade product performance. Thermally conductive materials are typically used to dissipate heat in many devices such as, for example, LED lamps, e-motors, circuits, processors and coil bobbins. More recently, new market applications involve thermal management, including thermal dissipation in mobile phone devices and mobile Wi-Fi. These electronic devices require materials with different properties than those mandated by earlier devices. This new market has generated a need for suitable polymer compositions that have improved mechanical performance properties, such as high impact strength and ductility, while retaining required properties of thermal conductivity, robust flame retardance, and superior heat dissipation.

Accordingly, there is a growing need for thermally conductive polymer compositions formed from amorphous polymer resins which provide improved impact performance, increased ductility, robust flame retardance, and superior heat dissipation

### SUMMARY OF THE INVENTION

The present invention relates to blended thermoplastic polymer compositions comprising one or more polycarbonate polymers and one or more thermally conductive fillers, wherein the blended polymer composition have both excellent thermal conductivity and mechanical performance properties.

In one aspect, the invention relates to blended thermoplastic compositions comprising: (a) from about 20 wt % to about 80 wt % of a first polycarbonate polymer component; (b) from about 1 wt % to about 30 wt % of a second polycarbonate polymer component, wherein the second polycarbonate polymer component is a branched chain polycarbonate polymer; (c) from about 1 wt % to about 30 wt % of at least one polycarbonate-polysiloxane copolymer component; and (d) from greater than 0 wt % to about 50 wt % of a thermally conductive filler component; wherein the combined weight percent value of all components does not exceed about 100 wt %; wherein all weight percent values are based on the total weight of the composition; wherein a molded sample of the blended thermoplastic composition has a through-plane thermal conductivity when determined in accordance with ASTM E1461 of greater than or equal to about 0.4 W/mK; and wherein a molded sample of the blended thermoplastic composition has an in-plane thermal conductivity when determined in accordance with ASTM E1461 of greater than or equal to about 1.0 W/mK.

In various further aspects, the invention relates to methods of preparing a blended thermoplastic composition, comprising mixing: (a) from about 20 wt % to about 80 wt % of a first polycarbonate polymer component; (b) from about 1 wt % to about 30 wt % of a second polycarbonate polymer component, wherein the second polycarbonate polymer component is a branched chain polycarbonate polymer; (c) from about 1 wt % to about 30 wt % of at least one polycarbonate-polysiloxane copolymer component; and (d) from greater than 0 wt % to about 50 wt % of a thermally conductive filler component; wherein the combined weight percent value of all components does not exceed about 100 wt %; wherein all weight percent values are based on the total weight of the composition; wherein a molded sample of the blended thermoplastic composition has a through-plane thermal conductivity when determined in accordance with ASTM E1461 of greater than or equal to about 0.4 W/mK; and wherein a molded sample of the blended thermoplastic composition has an in-plane thermal conductivity when determined in accordance with ASTM E1461 of greater than or equal to about 1.0 W/mK.

In various further aspects, the invention relates to articles comprising the disclosed compositions.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE INVENTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### A. DEFINITIONS

It is also to be understood that the terminology used herein is for the purpose of describing particular aspects only and is not intended to be limiting. As used in the specification and in the claims, the term “comprising” can include the aspects “consisting of” and “consisting essentially of”. Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polycarbonate poly” includes mixtures of two or more polycarbonate polymers.

As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

As used herein, the term “effective amount” refers to an amount that is sufficient to achieve the desired modification of a physical property of the composition or material. For example, an “effective amount” of a thermally conductive filler refers to an amount that is sufficient to achieve the desired improvement in the property modulated by the formulation component, e.g. achieving the desired level of thermal conductivity. The specific level in terms of wt % in a composition required as an effective amount will depend upon a variety of factors including the amount and type of polycarbonate, amount and type of polycarbonate, amount and type of thermally conductive filler, and end use of the article made using the composition.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Compounds are described using standard nomenclature. For example, any position not substituted by any indicated group is understood to have its valence filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this invention belongs.

The term “alkyl group” as used herein is a branched or unbranched saturated hydrocarbon group of 1 to 24 carbon atoms, such as methyl, ethyl, n propyl, isopropyl, n butyl, isobutyl, t butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “aralkyl” as used herein is an aryl group having an alkyl, alkynyl, or alkenyl group as defined above attached to the aromatic group. An example of an aralkyl group is a benzyl group.

The term “carbonate group” as used herein is represented by the formula OC(O)OR, where R can be hydrogen, an alkyl, alkenyl, alkynyl, aryl, aralkyl, cycloalkyl, halogenated alkyl, or heterocycloalkyl group described above.

The term “organic residue” defines a carbon containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, mono or di-substituted amino, amide groups, etc. Organic residues can preferably comprise 1 to 18 carbon atoms, 1 to 15, carbon atoms, 1 to 12 carbon atoms, 1 to 8 carbon atoms, 1 to 6 carbon atoms, or 1 to 4 carbon atoms. In a further aspect, an organic residue can comprise 2 to 18 carbon atoms, 2 to 15, carbon atoms, 2 to 12 carbon atoms, 2 to 8 carbon atoms, 2 to 4 carbon atoms, or 2 to 4 carbon atoms.

A very close synonym of the term “residue” is the term “radical,” which as used in the specification and concluding claims, refers to a fragment, group, or substructure of a molecule described herein, regardless of how the molecule is prepared. For example, a 2,4-dihydroxyphenyl radical in a particular compound has the structure:

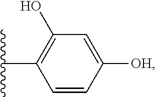 [SMILES: *c1ccc(O)cc1O]

regardless of whether 2,4-dihydroxyphenyl is used to prepare the compound. In some aspects the radical (for example an alkyl) can be further modified (i.e., substituted alkyl) by having bonded thereto one or more “substituent radicals.” The number of atoms in a given radical is not critical to the present invention unless it is indicated to the contrary elsewhere herein.

“Organic radicals,” as the term is defined and used herein, contain one or more carbon atoms. An organic radical can have, for example, 1-26 carbon atoms, 1-18 carbon atoms, 1-12 carbon atoms, 1-8 carbon atoms, 1-6 carbon atoms, or 1-4 carbon atoms. In a further aspect, an organic radical can have 2-26 carbon atoms, 2-18 carbon atoms, 2-12 carbon atoms, 2-8 carbon atoms, 2-6 carbon atoms, or 2-4 carbon atoms. Organic radicals often have hydrogen bound to at least some of the carbon atoms of the organic radical. One example, of an organic radical that comprises no inorganic atoms is a 5,6,7,8-tetrahydro-2-naphthyl radical. In some aspects, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

As used herein, the terms “number average molecular weight” or “Mₙ” can be used interchangeably, and refer to the statistical average molecular weight of all the polymer chains in the sample and is defined by the formula:

$${M}_{n} = \frac{\sum {N}_{i} {M}_{i}}{\sum {N}_{i}} ,$$

where Mᵢ is the molecular weight of a chain and Nᵢ is the number of chains of that molecular weight. Mₙ can be determined for polymers, e.g., polycarbonate polymers, by methods well known to a person having ordinary skill in the art using molecular weight standards, e.g. polycarbonate standards or polystyrene standards, preferably certified or traceable molecular weight standards.

As used herein, the terms “weight average molecular weight” or “Mw” can be used interchangeably, and are defined by the formula:

$${M}_{w} = \frac{\sum {N}_{i} {M}_{i}^{2}}{\sum {N}_{i} {M}_{i}} ,$$

where Mᵢ is the molecular weight of a chain and Nᵢ is the number of chains of that molecular weight. Compared to Mₙ, M_{w} takes into account the molecular weight of a given chain in determining contributions to the molecular weight average. Thus, the greater the molecular weight of a given chain, the more the chain contributes to the M_{w}. M_{w} can be determined for polymers, e.g. polycarbonate polymers, by methods well known to a person having ordinary skill in the art using molecular weight standards, e.g. polycarbonate standards or polystyrene standards, preferably certified or traceable molecular weight standards.

As used herein, the terms “polydispersity index” or “PDI” can be used interchangeably, and are defined by the formula:

$$PDI = \frac{{M}_{w}}{{M}_{n}} .$$

The PDI has a value equal to or greater than 1, but as the polymer chains approach uniform chain length, the PDI approaches unity.

The terms “BisA,” “BPA,” or “bisphenol A,” which can be used interchangeably, as used herein refers to a compound having a structure represented by the formula:

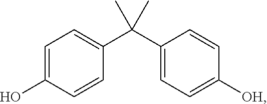 [SMILES: CC(C)(c1ccc(O)cc1)c1ccc(O)cc1]

BisA can also be referred to by the name 4,4′-(propane-2,2-diyl)diphenol; p,p′-isopropylidenebisphenol; or 2,2-bis(4-hydroxyphenyl)propane. BisA has the CAS #80-05-7.

As used herein, “polycarbonate” refers to an oligomer or polymer comprising residues of one or more dihydroxy compounds, e.g., dihydroxy aromatic compounds, joined by carbonate linkages; it also encompasses homopolycarbonates, copolycarbonates, and (co)polyester carbonates.

The terms “residues” and “structural units”, used in reference to the constituents of the polymers, are synonymous throughout the specification.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. BLENDED THERMOPLASTIC POLYMER COMPOSITIONS

As briefly described above, the present invention relates to blended thermoplastic polymer compositions comprising one or more polycarbonate polymers, and one or more thermally conductive fillers, wherein the blended polymer composition have both excellent thermal conductivity and mechanical performance properties.

In one aspect, the invention relates to blended thermoplastic compositions comprising: (a) from about 20 wt % to about 80 wt % of a first polycarbonate polymer component; (b) from about 1 wt % to about 30 wt % of a second polycarbonate polymer component, wherein the second polycarbonate polymer component is a branched chain polycarbonate polymer; (c) from about 1 wt % to about 30 wt % of at least one polycarbonate-polysiloxane copolymer component; and (d) from greater than 0 wt % to about 50 wt % of a thermally conductive filler component; wherein the combined weight percent value of all components does not exceed about 100 wt %; wherein all weight percent values are based on the total weight of the composition; wherein a molded sample of the blended thermoplastic composition has a through-plane thermal conductivity when determined in accordance with ASTM E1461 of greater than or equal to about 0.4 W/mK; and wherein a molded sample of the blended thermoplastic composition has an in-plane thermal conductivity when determined in accordance with ASTM E1461 of greater than or equal to about 1.0 W/mK.

In a further aspect, the molded sample of the blended thermoplastic compositions has a notched impact strength of from about 50 J/m to about 1000 J/m. In a still further aspect, the molded sample of the blended thermoplastic compositions has a notched impact strength of from about 50 J/m to about 800 J/m. In yet a further aspect, the molded sample of the blended thermoplastic compositions has a notched impact strength of from about 50 J/m to about 500 J/m.

In a further aspect, the molded sample of the blended thermoplastic compositions has an unnotched impact strength of from about 200 J/m to about 3000 J/m. In a still further aspect, the molded sample of the blended thermoplastic compositions has an unnotched impact strength of from about 200 J/m to about 2500 J/m. In yet a further aspect, the molded sample of the blended thermoplastic compositions has an unnotched impact strength of from about 200 J/m to about 1500 J/m.

In a further aspect, the molded sample of the blended thermoplastic compositions has a through-plane thermal conductivity of from about 0.4 W/mK to about 1.0 W/mK. In a still further aspect, the molded sample of the blended thermoplastic compositions has a through-plane thermal conductivity of from about 0.4 W/mK to about 0.8 W/mK. In yet a further aspect, the molded sample of the blended thermoplastic compositions has a through-plane thermal conductivity of from about 0.4 W/mK to about 0.6 W/mK.

In a further aspect, the molded sample of the blended thermoplastic compositions has an in-plane thermal conductivity of from about 1.0 W/mK to about 4.0 W/mK. In a still further aspect, the molded sample of the blended thermoplastic compositions has an in-plane thermal conductivity of from about 1.0 W/mK to about 3.0 W/mK. In yet a further aspect, the molded sample of the blended thermoplastic compositions has an in-plane thermal conductivity of from about 1.0 W/mK to about 2.5 W/mK.

In various aspects, the compositions of the present invention further comprise an additive selected from coupling agents, antioxidants, mold release agents, UV absorbers, light stabilizers, heat stabilizers, lubricants, plasticizers, pigments, dyes, colorants, anti-static agents, nucleating agents, anti-drip agents, acid scavengers, and combinations of two or more of the foregoing. In a further aspect, compositions of the present invention further comprise at least one additive selected from a flame retardant, a colorant, a primary anti-oxidant, and a secondary anti-oxidant.

### C. POLYCARBONATE POLYMER COMPONENT

In one aspect, the disclosed polymer compositions comprise a first polycarbonate polymer composition wherein the first polycarbonate polymer comprises bisphenol A, a polycarbonate copolymer, or polyester carbonate polymer, or combinations thereof.

In one aspect, a polycarbonate can comprise any polycarbonate material or mixture of materials, for example, as recited in U.S. Pat. No. 7,786,246, which is hereby incorporated in its entirety for the specific purpose of disclosing various polycarbonate compositions and methods. The term polycarbonate can be further defined as compositions have repeating structural units of the formula (1):

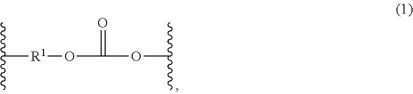

in which at least 60 percent of the total number of R¹ groups are aromatic organic radicals and the balance thereof are aliphatic, alicyclic, or aromatic radicals. In a further aspect, each R¹ is an aromatic organic radical and, more preferably, a radical of the formula (2):

-A¹-Y¹-A²- (2),

wherein each of A¹ and A² is a monocyclic divalent aryl radical and Y¹ is a bridging radical having one or two atoms that separate A¹ from A². In various aspects, one atom separates A¹ from A². For example, radicals of this type include, but are not limited to, radicals such as —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ is preferably a hydrocarbon group or a saturated hydrocarbon group such as methylene, cyclohexylidene, or isopropylidene.

In a further aspect, polycarbonates can be produced by the interfacial reaction of dihydroxy compounds having the formula HO—R¹—OH, which includes dihydroxy compounds of formula (3):

HO-A¹-Y¹-A²-OH (3),

wherein Y¹, A¹ and A² are as described above. Also included are bisphenol compounds of general formula (4):

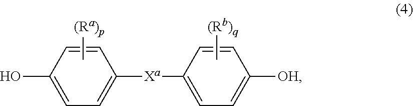

wherein R^{a} and R^{b} each represent a halogen atom or a monovalent hydrocarbon group and can be the same or different; p and q are each independently integers from 0 to 4; and X^{a} represents one of the groups of formula (5):

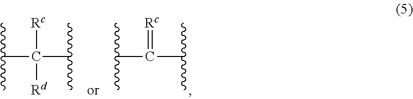

wherein R^{c} and R^{d} each independently represent a hydrogen atom or a monovalent linear or cyclic hydrocarbon group and R^{e} is a divalent hydrocarbon group.

In various aspects, a heteroatom-containing cyclic alkylidene group comprises at least one heteroatom with a valency of 2 or greater, and at least two carbon atoms. Heteroatoms for use in the heteroatom-containing cyclic alkylidene group include —O—, —S—, and —N(Z)—, where Z is a substituent group selected from hydrogen, hydroxy, C₁₋₁₂ alkyl, C₁₋₁₂ alkoxy, or C₁₋₁₂ acyl. Where present, the cyclic alkylidene group or heteroatom-containing cyclic alkylidene group can have 3 to 20 atoms, and can be a single saturated or unsaturated ring, or fused polycyclic ring system wherein the fused rings are saturated, unsaturated, or aromatic.

In various aspects, examples of suitable dihydroxy compounds include the dihydroxy-substituted hydrocarbons disclosed by name or formula (generic or specific) in U.S. Pat. No. 4,217,438. A nonexclusive list of specific examples of suitable dihydroxy compounds includes the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, 2,7-dihydroxycarbazole, 3,3-bis(4-hydroxyphenyl)phthalimidine, 2-phenyl-3,3-bis-(4-hydroxyphenyl)phthalimidine (PPPBP), and the like, as well as mixtures including at least one of the foregoing dihydroxy compounds.

In a further aspect, examples of the types of bisphenol compounds that can be represented by formula (3) includes 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl) n-butane, 2,2-bis(4-hydroxy-1-methylphenyl)propane, and 1,1-bis(4-hydroxy-t-butylphenyl)propane. Combinations including at least one of the foregoing dihydroxy compounds can also be used.

In various further aspects, bisphenols containing substituted or unsubstituted cyclohexane units can be used, for example bisphenols of formula (6):

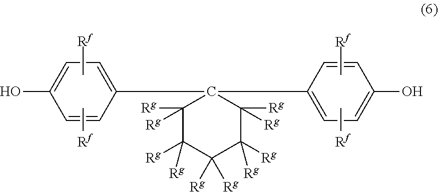

wherein each R^{f} is independently hydrogen, C₁₋₁₂ alkyl, or halogen; and each R^{g} is independently hydrogen or C₁₋₁₂ alkyl. The substituents can be aliphatic or aromatic, straight chain, cyclic, bicyclic, branched, saturated, or unsaturated. Such cyclohexane-containing bisphenols, for example the reaction product of two moles of a phenol with one mole of a hydrogenated isophorone, are useful for making polycarbonate polymers with high glass transition temperatures and high heat distortion temperatures. Cyclohexyl bisphenol containing polycarbonates, or a combination comprising at least one of the foregoing with other bisphenol polycarbonates, are supplied by Bayer Co. under the APEC® trade name.

In further aspects, additional useful dihydroxy compounds are those compounds having the formula HO—R¹—OH include aromatic dihydroxy compounds of formula (7):

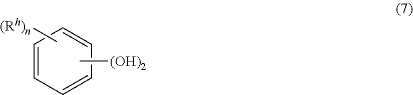

wherein each R^{h} is independently a halogen atom, a C₁₋₁₀ hydrocarbyl such as a C₁₋₁₀ alkyl group, a halogen substituted C₁₋₁₀ hydrocarbyl such as a halogen-substituted C₁₋₁₀ alkyl group, and n is 0 to 4. The halogen is usually bromine.

In addition to the polycarbonates described above, combinations of the polycarbonate with other thermoplastic polymers, for example combinations of homopolycarbonates and/or polycarbonate copolymers, can be used.

In various aspects, a polycarbonate can employ two or more different dihydroxy compounds or a copolymer of a dihydroxy compounds with a glycol or with a hydroxy- or acid-terminated polyester or with a dibasic acid or hydroxy acid in the event a carbonate copolymer rather than a homopolymer is desired for use. Polyarylates and polyester-carbonate resins or their blends can also be employed. Branched polycarbonates are also useful, as well as blends of linear polycarbonate and a branched polycarbonate. The branched polycarbonates can be prepared by adding a branching agent during polymerization.

In a further aspect, the branching agents include polyfunctional organic compounds containing at least three functional groups selected from hydroxyl, carboxyl, carboxylic anhydride, haloformyl, and mixtures thereof. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha,alpha-dimethyl benzyl)phenol), 4-chloroformyl phthalic anhydride, trimesic acid, and benzophenone tetracarboxylic acid. The branching agents can be added at a level of from 0.05-2.0 weight percent. Branching agents and procedures for making branched polycarbonates are described in U.S. Pat. Nos. 3,635,895 and 4,001,184. All types of polycarbonate end groups are contemplated as being useful in the thermoplastic composition.

In a further aspect, the polycarbonate can be a linear homopolymer derived from bisphenol A, in which each of A¹ and A² is p-phenylene and Y¹ is isopropylidene. The polycarbonates generally can have an intrinsic viscosity, as determined in chloroform at 25° C., of 0.3 to 1.5 deciliters per gram (dl/g), specifically 0.45 to 1.0 dl/g. The polycarbonates can have a weight average molecular weight (Mw) of 10,000 to 100,000 g/mol, as measured by gel permeation chromatography (GPC) using a crosslinked styrene-divinyl benzene column, at a sample concentration of 1 milligram per milliliter, and as calibrated with polycarbonate standards. In a yet further aspect, the polycarbonate has a Mw of about 15,000 to about 55,000. In an even further aspect, the polycarbonate has a Mw of about 18,000 to about 40,000.

Polycarbonates, including isosorbide-based polyester-polycarbonate, can comprise copolymers comprising carbonate units and other types of polymer units, including ester units, and combinations comprising at least one of homopolycarbonates and copolycarbonates. An exemplary polycarbonate copolymer of this type is a polyester carbonate, also known as a polyester-polycarbonate or polyester carbonate. Such copolymers further contain carbonate units derived from oligomeric ester-containing dihydroxy compounds (also referred to herein as hydroxy end-capped oligomeric acrylate esters).

In various further aspects, “polycarbonates” and “polycarbonate resins” as used herein further include homopolycarbonates, copolymers comprising different R¹ moieties in the carbonate (referred to herein as “copolycarbonates”), copolymers comprising carbonate units and other types of polymer units, such as ester units, polysiloxane units, and combinations comprising at least one of homopolycarbonates and copolycarbonates. As used herein, “combination” is inclusive of blends, mixtures, alloys, reaction products, and the like. A specific type of copolymer is a polyester carbonate, also known as a polyester-polycarbonate. Such copolymers further contain, in addition to recurring carbonate chain units of the formula (1), units of formula (8):

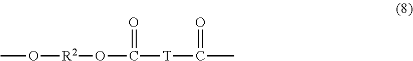

wherein R² is a divalent group derived from a dihydroxy compound, and can be, for example, a C₂₋₁₀ alkylene group, a C₆₋₂₀ alicyclic group, a C₆₋₂₀ aromatic group or a polyoxyalkylene group in which the alkylene groups contain 2 to about 6 carbon atoms, specifically 2, 3, or 4 carbon atoms; and T is a divalent group derived from a dicarboxylic acid (aliphatic, aromatic, or alkyl aromatic), and can be, for example, a C₄₋₁₈ aliphatic group, a C₆₋₂₀ alkylene group, a C₆₋₂₀ alkylene group, a C₆₋₂₀ alicyclic group, a C₆₋₂₀ alkyl aromatic group, or a C₆₋₂₀ aromatic group. R² can be is a C₂₋₃₀ alkylene group having a straight chain, branched chain, or cyclic (including polycyclic) structure. Alternatively, R² can be derived from an aromatic dihydroxy compound of formula (4) above, or from an aromatic dihydroxy compound of formula (7) above.

Examples of aromatic dicarboxylic acids that can be used to prepare the polyester units include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Examples of specific dicarboxylic acids are terephthalic acid, isophthalic acid, naphthalene dicarboxylic acid, cyclohexane dicarboxylic acid, or combinations thereof. In various aspects, an example of a specific dicarboxylic acid comprises a combination of isophthalic acid and terephthalic acid wherein the weight ratio of isophthalic acid to terephthalic acid is about 91:9 to about 2:98. In another aspect, R² is a C₂₋₆ alkylene group and T is p-phenylene, m-phenylene, naphthalene, a divalent cycloaliphatic group, or a combination thereof. This class of polyester includes the poly(alkylene terephthalates).

In one aspect, the thermoplastic composition may comprise a polyester-polycarbonate copolymer, and specifically a polyester-polycarbonate copolymer in which the ester units of formula (8) comprise soft block ester units, also referred to herein as aliphatic dicarboxylic acid ester units. Such a polyester-polycarbonate copolymer comprising soft block ester units is also referred to herein as a poly(aliphatic ester)-polycarbonate. The soft block ester unit can be a C₆₋₂₀ aliphatic dicarboxylic acid ester unit (where C₆₋₂₀ includes the terminal carboxyl groups), and can be straight chain (i.e., unbranched) or branched chain dicarboxylic acids, cycloalkyl or cycloalkylidene-containing dicarboxylic acids units, or combinations of these structural units. In a still further aspect, the C₆₋₂₀ aliphatic dicarboxylic acid ester unit includes a straight chain alkylene group comprising methylene (—CH₂—) repeating units. In a yet further aspect, a useful soft block ester unit comprises units of formula (8a):

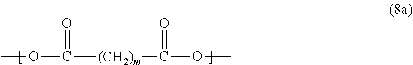

where m is 4 to 18. In a further aspect of formula (8a), m is 8 to 10. The poly(aliphatic ester)-polycarbonate can include less than or equal to 25 wt % of the soft block unit. In a still further aspect, a poly(aliphatic ester)-polycarbonate comprises units of formula (8a) in an amount of 0.5 to 10 wt %, specifically 1 to 9 wt %, and more specifically 3 to 8 wt %, based on the total weight of the poly(aliphatic ester)-polycarbonate.

The poly(aliphatic ester)-polycarbonate is a copolymer of soft block ester units and carbonate units. The poly(aliphatic ester)-polycarbonate is shown in formula (8b):

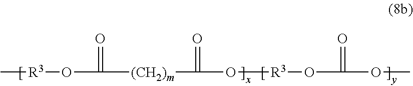

where each R³ is independently derived from a dihydroxyaromatic compound of formula (4) or (7), m is 4 to 18, and x and y each represent average weight percentages of the poly(aliphatic ester)-polycarbonate where the average weight percentage ratio x:y is 10:90 to 0.5:99.5, specifically 9:91 to 1:99, and more specifically 8:92 to 3:97, where x+y is 100.

Soft block ester units, as defined herein, can be derived from an alpha, omega C₆₋₂₀ aliphatic dicarboxylic acid or a reactive derivative thereof. In a further aspect, the soft block ester units can be derived from an alpha, omega C₁₀₋₁₂ aliphatic dicarboxylic acid or a reactive derivative thereof. In a still further aspect, the carboxylate portion of the aliphatic ester unit of formula (8a), in which the terminal carboxylate groups are connected by a chain of repeating methylene (—CH₂—) units (where m is as defined for formula (8a)), is derived from the corresponding dicarboxylic acid or reactive derivative thereof, such as the acid halide (specifically, the acid chloride), an ester, or the like. Exemplary alpha, omega dicarboxylic acids (from which the corresponding acid chlorides can be derived) include alpha, omega C₆ dicarboxylic acids such as hexanedioic acid (also referred to as adipic acid); alpha, omega C₁₀ dicarboxylic acids such as decanedioic acid (also referred to as sebacic acid); and alpha, omega C₁₂ dicarboxylic acids such as dodecanedioic acid (sometimes abbreviated as DDDA). It will be appreciated that the aliphatic dicarboxylic acid is not limited to these exemplary carbon chain lengths, and that other chain lengths within the C₆₋₂₀ limitation can be used. In various further aspects, the poly(aliphatic ester)-polycarbonate having soft block ester units comprising a straight chain methylene group and a bisphenol A polycarbonate group is shown in formula (8c):

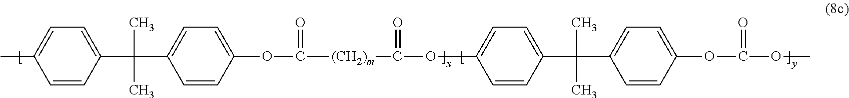

where m is 4 to 18 and x and y are as defined for formula (8b). In a specific exemplary aspect, a useful poly(aliphatic ester)-polycarbonate copolymer comprises sebacic acid ester units and bisphenol A carbonate units (formula (8c), where m is 8, and the average weight ratio of x:y is 6:94).

In one aspect, polycarbonates, including polyester-polycarbonates, can be manufactured by processes such as interfacial polymerization and melt polymerization.

The polycarbonate compounds and polymers disclosed herein can, in various aspects, be prepared by a melt polymerization process. Generally, in the melt polymerization process, polycarbonates are prepared by co-reacting, in a molten state, the dihydroxy reactant(s) (i.e., isosorbide, aliphatic diol and/or aliphatic diacid, and any additional dihydroxy compound) and a diaryl carbonate ester, such as diphenyl carbonate, or more specifically in an aspect, an activated carbonate such as bis(methyl salicyl)carbonate, in the presence of a transesterification catalyst. The reaction can be carried out in typical polymerization equipment, such as one or more continuously stirred reactors (CSTRs), plug flow reactors, wire wetting fall polymerizers, free fall polymerizers, wiped film polymerizers, BANBURY® mixers, single or twin screw extruders, or combinations of the foregoing. In one aspect, volatile monohydric phenol can be removed from the molten reactants by distillation and the polymer is isolated as a molten residue.

The melt polymerization can include a transesterification catalyst comprising a first catalyst, also referred to herein as an alpha catalyst, comprising a metal cation and an anion. In an aspect, the cation is an alkali or alkaline earth metal comprising Li, Na, K, Cs, Rb, Mg, Ca, Ba, Sr, or a combination comprising at least one of the foregoing. The anion is hydroxide (OH⁻), superoxide (O²⁻), thiolate (HS⁻), sulfide (S²⁻), a C₁₋₂₀ alkoxide, a C₆₋₂₀ aryloxide, a C₁₋₂₀ carboxylate, a phosphate including biphosphate, a C₁₋₂₀ phosphonate, a sulfate including bisulfate, sulfites including bisulfites and metabisulfites, a C₁₋₂₀ sulfonate, a carbonate including bicarbonate, or a combination comprising at least one of the foregoing. In another aspect, salts of an organic acid comprising both alkaline earth metal ions and alkali metal ions can also be used. Salts of organic acids useful as catalysts are illustrated by alkali metal and alkaline earth metal salts of formic acid, acetic acid, stearic acid and ethyelenediaminetetraacetic acid. The catalyst can also comprise the salt of a non-volatile inorganic acid. By “nonvolatile”, it is meant that the referenced compounds have no appreciable vapor pressure at ambient temperature and pressure. In particular, these compounds are not volatile at temperatures at which melt polymerizations of polycarbonate are typically conducted. The salts of nonvolatile acids are alkali metal salts of phosphites; alkaline earth metal salts of phosphites; alkali metal salts of phosphates; and alkaline earth metal salts of phosphates. Exemplary transesterification catalysts include, lithium hydroxide, sodium hydroxide, potassium hydroxide, cesium hydroxide, magnesium hydroxide, calcium hydroxide, barium hydroxide, lithium formate, sodium formate, potassium formate, cesium formate, lithium acetate, sodium acetate, potassium acetate, lithium carbonate, sodium carbonate, potassium carbonate, lithium methoxide, sodium methoxide, potassium methoxide, lithium ethoxide, sodium ethoxide, potassium ethoxide, lithium phenoxide, sodium phenoxide, potassium phenoxide, sodium sulfate, potassium sulfate, NaH₂PO₃, NaH₂PO₄, Na₂H₂PO₃, KH₂PO₄, CsH₂PO₄, Cs₂H₂PO₄, Na₂SO₃, Na₂S₂O₅, sodium mesylate, potassium mesylate, sodium tosylate, potassium tosylate, magnesium disodium ethylenediamine tetraacetate (EDTA magnesium disodium salt), or a combination comprising at least one of the foregoing. It will be understood that the foregoing list is exemplary and should not be considered as limited thereto. In one aspect, the transesterification catalyst is an alpha catalyst comprising an alkali or alkaline earth salt. In an exemplary aspect, the transesterification catalyst comprising sodium hydroxide, potassium hydroxide, sodium carbonate, potassium carbonate, sodium methoxide, potassium methoxide, NaH₂PO₄, or a combination comprising at least one of the foregoing.

The amount of alpha catalyst can vary widely according to the conditions of the melt polymerization, and can be about 0.001 to about 500 μmol. In an aspect, the amount of alpha catalyst can be about 0.01 to about 20 μmol, specifically about 0.1 to about 10 μmol, more specifically about 0.5 to about 9 μmol, and still more specifically about 1 to about 7 μmol, per mole of aliphatic diol and any other dihydroxy compound present in the melt polymerization.

In another aspect, a second transesterification catalyst, also referred to herein as a beta catalyst, can optionally be included in the melt polymerization process, provided that the inclusion of such a second transesterification catalyst does not significantly adversely affect the desirable properties of the polycarbonate. Exemplary transesterification catalysts can further include a combination of a phase transfer catalyst of formula (R³)₄Q⁺X above, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalyst salts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. Examples of such transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing. Other melt transesterification catalysts include alkaline earth metal salts or alkali metal salts. In various aspects, where a beta catalyst is desired, the beta catalyst can be present in a molar ratio, relative to the alpha catalyst, of less than or equal to 10, specifically less than or equal to 5, more specifically less than or equal to 1, and still more specifically less than or equal to 0.5. In other aspects, the melt polymerization reaction disclosed herein uses only an alpha catalyst as described hereinabove, and is substantially free of any beta catalyst. As defined herein, “substantially free of” can mean where the beta catalyst has been excluded from the melt polymerization reaction. In one aspect, the beta catalyst is present in an amount of less than about 10 ppm, specifically less than 1 ppm, more specifically less than about 0.1 ppm, more specifically less than or equal to about 0.01 ppm, and more specifically less than or equal to about 0.001 ppm, based on the total weight of all components used in the melt polymerization reaction.

In one aspect, an end-capping agent (also referred to as a chain-stopper) can optionally be used to limit molecular weight growth rate, and so control molecular weight in the polycarbonate. Exemplary chain-stoppers include certain monophenolic compounds (i.e., phenyl compounds having a single free hydroxy group), monocarboxylic acid chlorides, and/or monochloroformates. Phenolic chain-stoppers are exemplified by phenol and C₁-C₂₂ alkyl-substituted phenols such as p-cumyl-phenol, resorcinol monobenzoate, and p- and tertiary-butyl phenol, cresol, and monoethers of diphenols, such as p-methoxyphenol. Alkyl-substituted phenols with branched chain alkyl substituents having 8 to 9 carbon atoms can be specifically mentioned.

In another aspect, endgroups can be derived from the carbonyl source (i.e., the diaryl carbonate), from selection of monomer ratios, incomplete polymerization, chain scission, and the like, as well as any added end-capping groups, and can include derivatizable functional groups such as hydroxy groups, carboxylic acid groups, or the like. In one aspect, the endgroup of a polycarbonate, including a polycarbonate polymer as defined herein, can comprise a structural unit derived from a diaryl carbonate, where the structural unit can be an endgroup. In a further aspect, the endgroup is derived from an activated carbonate. Such endgroups can be derived from the transesterification reaction of the alkyl ester of an appropriately substituted activated carbonate, with a hydroxy group at the end of a polycarbonate polymer chain, under conditions in which the hydroxy group reacts with the ester carbonyl from the activated carbonate, instead of with the carbonate carbonyl of the activated carbonate. In this way, structural units derived from ester containing compounds or substructures derived from the activated carbonate and present in the melt polymerization reaction can form ester endgroups.

In one aspect, the melt polymerization reaction can be conducted by subjecting the reaction mixture to a series of temperature-pressure-time protocols. In some aspects, this involves gradually raising the reaction temperature in stages while gradually lowering the pressure in stages. In one aspect, the pressure is reduced from about atmospheric pressure at the start of the reaction to about 1 millibar (100 Pa) or lower, or in another aspect to 0.1 millibar (10 Pa) or lower in several steps as the reaction approaches completion. The temperature can be varied in a stepwise fashion beginning at a temperature of about the melting temperature of the reaction mixture and subsequently increased to final temperature. In one aspect, the reaction mixture is heated from room temperature to about 150° C. In such an aspect, the polymerization reaction starts at a temperature of about 150° C. to about 220° C. In another aspect, the polymerization temperature can be up to about 220° C. In other aspects, the polymerization reaction can then be increased to about 250° C. and then optionally further increased to a temperature of about 320° C., and all subranges there between. In one aspect, the total reaction time can be from about 30 minutes to about 200 minutes and all subranges there between. This procedure will generally ensure that the reactants react to give polycarbonates with the desired molecular weight, glass transition temperature and physical properties. The reaction proceeds to build the polycarbonate chain with production of ester-substituted alcohol by-product such as methyl salicylate. In one aspect, efficient removal of the by-product can be achieved by different techniques such as reducing the pressure. Generally the pressure starts relatively high in the beginning of the reaction and is lowered progressively throughout the reaction and temperature is raised throughout the reaction.

In one aspect, the progress of the reaction can be monitored by measuring the melt viscosity or the weight average molecular weight of the reaction mixture using techniques known in the art such as gel permeation chromatography. These properties can be measured by taking discrete samples or can be measured on-line. After the desired melt viscosity and/or molecular weight is reached, the final polycarbonate product can be isolated from the reactor in a solid or molten form. It will be appreciated by a person skilled in the art, that the method of making aliphatic homopolycarbonate and aliphatic-aromatic copolycarbonates as described in the preceding sections can be made in a batch or a continuous process and the process disclosed herein is preferably carried out in a solvent free mode. Reactors chosen should ideally be self-cleaning and should minimize any “hot spots.” However, vented extruders similar to those that are commercially available can be used.

Polycarbonates, including polyester-polycarbonates, can be also be manufactured by interfacial polymerization. Although the reaction conditions for interfacial polymerization can vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like.

Carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In an exemplary aspect, an interfacial polymerization reaction to form carbonate linkages uses phosgene as a carbonate precursor, and is referred to as a phosgenation reaction.

Among the phase transfer catalysts that can be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Useful phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst can be about 0.1 to about 10 wt % based on the weight of bisphenol in the phosgenation mixture. In another aspect, an effective amount of phase transfer catalyst can be about 0.5 to about 2 wt % based on the weight of bisphenol in the phosgenation mixture.

All types of polycarbonate end groups are contemplated as being useful in the polycarbonate composition, provided that such end groups do not significantly adversely affect desired properties of the compositions.

Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha,alpha-dimethyl benzyl)phenol), 4-chloroformyl phthalic anhydride, trimesic acid, and benzophenone tetracarboxylic acid. The branching agents can be added at a level of about 0.05 to about 2.0 wt %. Mixtures comprising linear polycarbonates and branched polycarbonates can be used.

A chain stopper (also referred to as a capping agent) can be included during polymerization. The chain stopper limits molecular weight growth rate, and so controls molecular weight in the polycarbonate. Exemplary chain stoppers include certain mono-phenolic compounds, mono-carboxylic acid chlorides, and/or mono-chloroformates. Mono-phenolic chain stoppers are exemplified by monocyclic phenols such as phenol and C₁-C₂₂ alkyl-substituted phenols such as p-cumyl-phenol, resorcinol monobenzoate, and p- and tertiary-butyl phenol; and monoethers of diphenols, such as p-methoxyphenol. Alkyl-substituted phenols with branched chain alkyl substituents having 8 to 9 carbon atom can be specifically mentioned. Certain mono-phenolic UV absorbers can also be used as a capping agent, for example 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

Mono-carboxylic acid chlorides can also be used as chain stoppers. These include monocyclic, mono-carboxylic acid chlorides such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and combinations thereof; polycyclic, mono-carboxylic acid chlorides such as trimellitic anhydride chloride, and naphthoyl chloride; and combinations of monocyclic and polycyclic mono-carboxylic acid chlorides. Chlorides of aliphatic monocarboxylic acids with less than or equal to about 22 carbon atoms are useful. Functionalized chlorides of aliphatic monocarboxylic acids, such as acryloyl chloride and methacryoyl chloride, are also useful. Also useful are mono-chloroformates including monocyclic, mono-chloroformates, such as phenyl chloroformate, alkyl-substituted phenyl chloroformate, p-cumyl phenyl chloroformate, toluene chloroformate, and combinations thereof.

Specifically, polyester-polycarbonates, including the poly(aliphatic ester)-polycarbonates, can be prepared by interfacial polymerization. Rather than utilizing the dicarboxylic acid (such as the alpha, omega C₆₋₂₀ aliphatic dicarboxylic acid) per se, it is possible, and sometimes even preferred, to employ the reactive derivatives of the dicarboxylic acid, such as the corresponding dicarboxylic acid halides, and in particular the acid dichlorides and the acid dibromides. Thus, for example instead of using isophthalic acid, terephthalic acid, or a combination comprising at least one of the foregoing (for poly(arylate ester)-polycarbonates), it is possible to employ isophthaloyl dichloride, terephthaloyl dichloride, and a combination comprising at least one of the foregoing. Similarly, for the poly(aliphatic ester)-polycarbonates, it is possible, and even desirable, to use for example acid chloride derivatives such as a C₆ dicarboxylic acid chloride (adipoyl chloride), a C₁₀ dicarboxylic acid chloride (sebacoyl chloride), or a C₁₂ dicarboxylic acid chloride (dodecanedioyl chloride). The dicarboxylic acid or reactive derivative can be condensed with the dihydroxyaromatic compound in a first condensation, followed by in situ phosgenation to generate the carbonate linkages with the dihydroxyaromatic compound. Alternatively, the dicarboxylic acid or derivative can be condensed with the dihydroxyaromatic compound simultaneously with phosgenation.

In an aspect, where the melt volume rate of an otherwise compositionally suitable poly(aliphatic ester)-polycarbonate is not suitably high, i.e., where the MVR is less than 13 cc/10 min when measured at 250° C., under a load of 1.2 kg, the poly(aliphatic ester)-polycarbonate can be modified to provide a reaction product with a higher flow (i.e., greater than or equal to 13 cc/10 min when measured at 250° C., under a load of 1.2 kg), by treatment using a redistribution catalyst under conditions of reactive extrusion. During reactive extrusion, the redistribution catalyst is typically included in small amounts of less than or equal to 400 ppm by weight, by injecting a dilute aqueous solution of the redistribution catalyst into the extruder being fed with the poly(aliphatic ester)-polycarbonate.

In a further aspect, the redistribution-catalyst is a tetraalkylphosphonium hydroxide, tetraalkylphosphonium alkoxide, tetraalkylphosphonium aryloxide, a tetraalkylphosphonium carbonate, a tetraalkylammonium hydroxide, a tetraalkylammonium carbonate, a tetraalkylammonium phosphite, a tetraalkylammonium acetate, or a combination comprising at least one of the foregoing catalysts, wherein each alkyl is independently a C₁₋₆ alkyl. In a specific aspect, a useful redistribution catalyst is a tetra C₁₋₆ alkylphosphonium hydroxide, C₁₋₆ alkyl phosphonium phenoxide, or a combination comprising one or more of the foregoing catalysts. An exemplary redistribution catalyst is tetra-n-butylphosphonium hydroxide.

In a further aspect, the redistribution catalyst is present in an amount of 40 to 120 ppm, specifically 40 to 110 ppm, and more specifically 40 to 100 ppm, by weight based on the weight of the poly(aliphatic ester)-polycarbonate.

Polycarbonates as broadly defined above can further include blends of the above polycarbonates with polyesters. Useful polyesters can include, for example, polyesters having repeating units of formula (8), which include poly(alkylene dicarboxylates), liquid crystalline polyesters, and polyester copolymers. The polyesters described herein are generally completely miscible with the polycarbonates when blended.

Such polyesters generally include aromatic polyesters, poly(alkylene esters) including poly(alkylene arylates), and poly(cycloalkylene diesters). Aromatic polyesters can have a polyester structure according to formula (8), wherein D and T are each aromatic groups as described hereinabove. In an aspect, useful aromatic polyesters can include, for example, poly(isophthalate-terephthalate-resorcinol)esters, poly(isophthalate-terephthalate-bisphenol A)esters, poly[(isophthalate-terephthalate-resorcinol)ester-co-(isophthalate-terephthalate-bisphenol A)]ester, or a combination comprising at least one of these. Also contemplated are aromatic polyesters with a minor amount, e.g., about 0.5 to about 10 wt %, based on the total weight of the polyester, of units derived from an aliphatic diacid and/or an aliphatic polyol to make copolyesters. Poly(alkylene arylates) can have a polyester structure according to formula (8), wherein T comprises groups derived from aromatic dicarboxylates, cycloaliphatic dicarboxylic acids, or derivatives thereof. Examples of specifically useful T groups include 1,2-, 1,3-, and 1,4-phenylene; 1,4- and 1,5-naphthylenes; cis- or trans-1,4-cyclohexylene; and the like. Specifically, where T is 1,4-phenylene, the poly(alkylene arylate) is a poly(alkylene terephthalate). In addition, for poly(alkylene arylate), specifically useful alkylene groups D include, for example, ethylene, 1,4-butylene, and bis-(alkylene-disubstituted cyclohexane) including cis- and/or trans-1,4-(cyclohexylene)dimethylene. Examples of poly(alkylene terephthalates) include poly(ethylene terephthalate) (PET), poly(1,4-butylene terephthalate) (PBT), and poly(propylene terephthalate) (PPT). Also useful are poly(alkylene naphthoates), such as poly(ethylene naphthanoate) (PEN), and poly(butylene naphthanoate) (PBN). A useful poly(cycloalkylene diester) is poly(cyclohexanedimethylene terephthalate) (PCT). Combinations comprising at least one of the foregoing polyesters can also be used.

Copolymers comprising alkylene terephthalate repeating ester units with other ester groups can also be useful. Useful ester units can include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s can also include poly(alkylene cyclohexanedicarboxylate)s. Of these, a specific example is poly(1,4-cyclohexanedimethanol-1,4-cyclohexanedicarboxylate) (PCCD), having recurring units of formula (9):

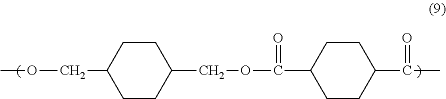

wherein, as described using formula (8), R² is a 1,4-cyclohexanedimethylene group derived from 1,4-cyclohexanedimethanol, and T is a cyclohexane ring derived from cyclohexanedicarboxylate or a chemical equivalent thereof, and can comprise the cis-isomer, the trans-isomer, or a combination comprising at least one of the foregoing isomers.

The polyesters can be obtained by interfacial polymerization or melt-process condensation as described above, by solution phase condensation, or by transesterification polymerization wherein, for example, a dialkyl ester such as dimethyl terephthalate can be transesterified with ethylene glycol using acid catalysis, to generate poly(ethylene terephthalate). It is possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

Polyester-polycarbonate copolymers generally can have a weight average molecular weight (Mw) of 1,500 to 100,000 g/mol, specifically 1,700 to 50,000 g/mol. In an aspect, poly(aliphatic ester)-polycarbonates have a molecular weight of 15,000 to 45,000 g/mol, specifically 17,000 to 40,000 g/mol, more specifically 20,000 to 30,000 g/mol, and still more specifically 20,000 to 25,000 g/mol. Molecular weight determinations are performed using gel permeation chromatography (GPC), using a crosslinked styrene-divinylbenzene column and calibrated to polycarbonate references. Samples are prepared at a concentration of about 1 mg/ml, and are eluted at a flow rate of about 1.0 ml/min.

A polyester-polycarbonate can in general have an MVR of about 5 to about 150 cc/10 min., specifically about 7 to about 125 cc/10 min, more specifically about 9 to about 110 cc/10 min, and still more specifically about 10 to about 100 cc/10 min., measured at 300° C. and a load of 1.2 kilograms according to ASTM D1238-04 or ISO 1133. Commercial polyester blends with polycarbonate are marketed under the trade name XYLEX®, including for example XYLEX® X7300, and commercial polyester-polycarbonates are marketed under the trade name LEXAN® SLX polymers, including for example LEXAN® SLX-9000, and are available from SABIC Innovative Plastics (formerly GE Plastics).

In a further aspect, the first polycarbonate polymer component is a homopolymer. In a still further aspect, the homopolymer comprises repeating units derived from bisphenol A.

In a further aspect, the first polycarbonate polymer component is a copolymer. In a still further aspect, the copolymer comprises repeating units derived from BPA. In yet a further aspect, the copolymer comprises repeating units derived from sebacic acid. In an even further aspect, the copolymer comprises repeating units derived from sebacic acid and BPA.

In a further aspect, the first polycarbonate polymer component has a weight average molecular weight from about 15,000 to about 75,000 grams/mole, as measured by gel permeation chromatography using BPA polycarbonate standards.

In a further aspect, the first polycarbonate polymer component is a blend comprising at least two polycarbonate polymers.

In a further aspect, the first polycarbonate polymer component is present in an amount from about 20 wt % to about 80 wt %. In a still further aspect, the polycarbonate polymer component is present in an amount from about 10 wt % to about 60 wt %. In yet a further aspect, the polycarbonate polymer component is present in an amount from about 10 wt % to about 50 wt %. In an even further aspect, the first polycarbonate polymer component is present in an amount from about 35 wt % to about 70 wt %. In a still further aspect, the first polycarbonate polymer component is present in an amount from about 35 wt % to about 60 wt %. In a yet further aspect, the first polycarbonate polymer component is present in an amount from about 45 wt % to about 70 wt %. In an even further aspect, the first polycarbonate polymer component is present in an amount from about 45 wt % to about 60 wt %. In a still further aspect, the first polycarbonate polymer component is present in an amount from about 60 wt % to about 70 wt %.

### D. BRANCHED CHAIN POLYCARBONATE POLYMER

In one aspect, the disclosed polymer compositions comprise a second polycarbonate polymer component, wherein the second polycarbonate polymer component is a branched chain polycarbonate polymer. In a further aspect, the second polycarbonate polymer component is selected from 1,1,1-tris-hydroxy phenyl ethane branched polycarbonate, 1,1,1-tris-hydroxy phenyl ethane branched polycarbonate that is end-capped with p-hydroxybenzonitrile, and trimellitic trichloride (TMTC) branched PC, or a mixture thereof. In a still further aspect, the second polycarbonate polymer component comprises residues derived from tris-(hydroxyphenyl)ethane. It is understood that tris-(hydroxyphenyl)ethane also refers to 1,1,1-tris-hydroxy phenyl ethane. In a yet further aspect, the second polycarbonate polymer component is end-capped with p-hydroxybenzonitrile.

Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha,alpha-dimethyl benzyl)phenol), 4-chloroformyl phthalic anhydride, trimesic acid, and benzophenone tetracarboxylic acid. The branching agents can be added at a level of about 0.05 to about 2.0 wt %. Mixtures comprising linear polycarbonates and branched polycarbonates can be used.

In various aspects, the second polycarbonate polymer component comprises residues derived from a branching agent selected from trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha,alpha-dimethyl benzyl)phenol), 4-chloroformyl phthalic anhydride, trimesic acid, and benzophenone tetracarboxylic acid.

In some aspects, a particular type of branching agent is used to create branched polycarbonate materials. These branched polycarbonate materials have statistically more than two end groups. The branching agent is added in an amount (relative to the bisphenol monomer) that is sufficient to achieve the desired branching content, that is, more than two end groups. The molecular weight of the polymer may become very high upon addition of the branching agent, and to avoid excess viscosity during polymerization, an increased amount of a chain stopper agent can be used, relative to the amount used when the particular branching agent is not present. The amount of chain stopper used is generally above 5 mole percent and less than 20 mole percent compared to the bisphenol monomer.

Such branching agents include aromatic triacyl halides, for example triacyl chlorides of formula (17):

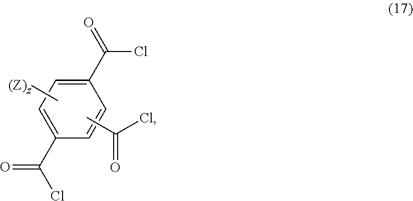

wherein Z is a halogen, C₁₋₃ alkyl, C₁₋₃ alkoxy, C₇₋₁₂ arylalkylene, C₇₋₁₂ alkylarylene, or nitro, and z is 0 to 3; a tri-substituted phenol of formula (18)

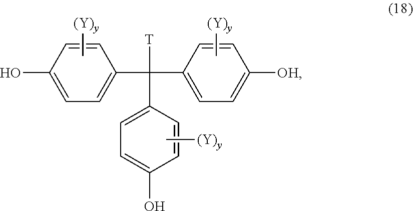

wherein T is a C₁₋₂₀ alkyl, C₁₋₂₀ alkyleneoxy, C₇₋₁₂ arylalkyl, or C₇₋₁₂ alkylaryl, Y is a halogen, C₁₋₃ alkyl, C₁₋₃ alkoxy, C₇₋₁₂ arylalkyl, C₇₋₁₂ alkylaryl, or nitro, y is 0 to 4; or a compound of formula (19) (isatin-bis-phenol):

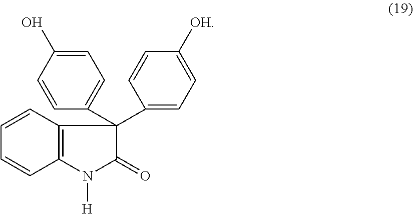 [SMILES: O=C1Nc2ccccc2C1(c1ccc(O)cc1)c1ccc(O)cc1]

Examples of specific branching agents that are particularly effective in the compositions include trimellitic trichloride (TMTC), tris-p-hydroxyphenylethane (THPE), and isatin-bis-phenol. In various aspects, the second polycarbonate polymer component comprises residues derived from a branching agent selected from trimellitic trichloride (TMTC), tris-p-hydroxyphenylethane, or alternatively referred to as tris-(hydroxyphenyl)ethane or 1,1,1-tris-hydroxy phenyl ethane (THPE), and isatin-bis-phenol. In a further aspect, the second polycarbonate polymer component comprises residues derived from branching agent trimellitic trichloride (TMTC). In a still further aspect, the second polycarbonate polymer component comprises residues derived from the branching agent tris-(hydroxyphenyl)ethane. In a yet further aspect, the second polycarbonate polymer component comprises residues derived from the branching agent isatin-bis-phenol.

The amount of the branching agents used in the manufacture of the polymer will depend on a number of considerations, for example the type of R¹ groups, the amount of chain stopper, e.g., cyanophenol, and the desired molecular weight of the polycarbonate. In general, the amount of branching agent is effective to provide 0.1 to 10 branching units per 100 R¹ units, specifically 0.5 to 8 branching units per 100 R¹ units, and more specifically 0.75 to 5 branching units per 100 R¹ units. For branching agents having formula (9), the branching agent triester groups are present in an amount of 0.1 to 10 branching units per 100 R¹ units, specifically 0.5 to 8 branching units per 100 R¹ units, and more specifically 0.75 to 5 branching agent triester units per 100 R¹ units. For branching agents having formula (10) or (11), the branching agent triphenyl carbonate groups formed are present in an amount of 0.1 to 10 branching units per 100 R¹ units, specifically 0.5 to 8 branching units per 100 R¹ units, and more specifically 0.75 to 5 triphenylcarbonate units per 100 R¹ units. In some aspects, a combination of two or more branching agents may be used. Alternatively, the branching agents can be added at a level of 0.05 to 2.0 wt. %.

In an aspect, the polycarbonate is a branched polycarbonate comprising units as described above; greater than or equal to 3 mole %, based on the total moles of the polycarbonate, of moieties derived from a branching agent; and end-capping groups derived from an end-capping agent having a pKₐ between 8.3 and 11. The branching agent can comprise trimellitic trichloride, 1,1,1-tris(4-hydroxyphenyl)ethane or a combination of trimellitic trichloride and 1,1,1-tris(4-hydroxyphenyl)ethane, and the end-capping agent is phenol or a phenol containing a substituent of cyano group, aliphatic groups, olefinic groups, aromatic groups, halogens, ester groups, ether groups, or a combination comprising at least one of the foregoing. In various aspects, the end-capping agent is phenol, p-t-butylphenol, p-methoxyphenol, p-cyanophenol, p-cumylphenol, p-hydroxybenzonitrile, or a combination comprising at least one of the foregoing. In a further aspect, the end-capping agent is phenol, p-t-butylphenol, p-methoxyphenol, p-cyanophenol, p-cumylphenol, or a combination comprising at least one of the foregoing.

In a further aspect, the branched chain polycarbonate polymer component is made by the interfacial process.

In various aspects, the second polycarbonate polymer component comprises residues derived from BPA.

In a further aspect, the second polycarbonate polymer component is present in an amount from about 1 wt % to about 30 wt %. In a still further aspect, the second polycarbonate polymer component is present in an amount from about 1 wt % to about 25 wt %. In yet a further aspect, the second polycarbonate polymer component is present in an amount from about 1 wt % to about 20 wt %. In an even further aspect, the second polycarbonate polymer component is present in an amount from about 5 wt % to about 25 wt %. In a still further aspect, the second polycarbonate polymer component is present in an amount from about 5 wt % to about 30 wt %. In a yet further aspect, the second polycarbonate polymer component is present in an amount from about 10 wt % to about 15 wt %. In an even further aspect, the second polycarbonate polymer component is present in an amount from about 10 wt % to about 20 wt %. In a still further aspect, the second polycarbonate polymer component is present in an amount from about 15 wt % to about 20 wt %.

### E. POLYCARBONATE-POLYSILOXANE COPOLYMER COMPONENT

In one aspect, the disclosed polymer compositions comprise at least one polycarbonate-polysiloxane copolymer component. The polysiloxane (also referred to herein as “polydiorganosiloxane”) blocks of the copolymer comprise repeating siloxane units (also referred to herein as “diorganosiloxane units”) of formula (10):

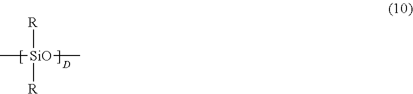

wherein each occurrence of R is same or different, and is a C₁₋₁₃ monovalent organic radical. For example, R can independently be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ arylalkyl group, C₇-C₁₃ arylalkoxy group, C₇-C₁₃ alkylaryl group, or C₇-C₁₃ alkylaryloxy group. The foregoing groups can be fully or partially halogenated with fluorine, chlorine, bromine, or iodine, or a combination thereof. Combinations of the foregoing R groups can be used in the same copolymer.

The value of D in formula (10) can vary widely depending on the type and relative amount of each component in the thermoplastic composition, the desired properties of the composition, and like considerations. Generally, D can have an average value of 2 to 1,000, specifically 2 to 500, more specifically 5 to 100. In some applications, D can have an average value of 30 to 60. An exemplary siloxane block can have an average D value of 45.

Where D is of a lower value, e.g., less than 40, it can be desirable to use a relatively larger amount of the polycarbonate-polysiloxane copolymer. Conversely, where D is of a higher value, e.g., greater than 40, it can be necessary to use a relatively lower amount of the polycarbonate-polysiloxane copolymer.

A combination of a first and a second (or more) polysiloxane-polycarbonate copolymer can be used, wherein the average value of D of the first copolymer is less than the average value of D of the second copolymer.

In one aspect, the polydiorganosiloxane blocks are provided by repeating structural units of formula (11):

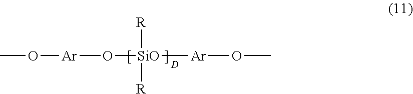

wherein D is as defined above; each R can independently be the same or different, and is as defined above; and each Ar can independently be the same or different, and is a substituted or unsubstituted C₆-C₃₀ arylene radical, wherein the bonds are directly connected to an aromatic moiety. Useful Ar groups in formula (11) can be derived from a C₆-C₃₀ dihydroxyarylene compound, for example a dihydroxyarylene compound of formula (3), (4), or (7) above. Combinations comprising at least one of the foregoing dihydroxyarylene compounds can also be used. Specific examples of dihydroxyarylene compounds are 1,1-bis(4-hydroxyphenyl)methane, 1,1-bis(4-hydroxyphenyl)ethane, 2,2-bis(4-hydroxyphenyl)propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxyphenyl)cyclohexane, bis(4-hydroxyphenyl sulphide), and 1,1-bis(4-hydroxy-t-butylphenyl)propane. Combinations comprising at least one of the foregoing dihydroxy compounds can also be used.

Units of formula (11) can be derived from the corresponding dihydroxy compound of formula (12):

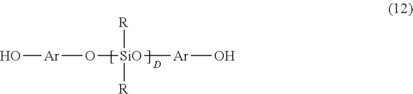

wherein R, Ar, and D are as described above. Compounds of formula (12) can be obtained by the reaction of a dihydroxyarylene compound with, for example, an alpha, omega-bisacetoxypolydiorangonosiloxane under phase transfer conditions.

In another aspect, polydiorganosiloxane blocks comprise units of formula (13):

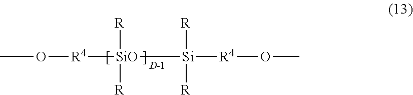

wherein R and D are as described above, and each occurrence of R⁴ is independently a divalent C₁-C₃₀ alkylene, and wherein the polymerized polysiloxane unit is the reaction residue of its corresponding dihydroxy compound. In a specific aspect, the polydiorganosiloxane blocks are provided by repeating structural units of formula (14):

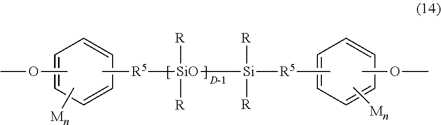

wherein R and D are as defined above. Each R⁵ in formula (14) is independently a divalent C₂-C₈ aliphatic group. Each M in formula (14) can be the same or different, and can be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy, wherein each n is independently 0, 1, 2, 3, or 4.

In one aspect, M is bromo or chloro, an alkyl group such as methyl, ethyl, or propyl, an alkoxy group such as methoxy, ethoxy, or propoxy, or an aryl group such as phenyl, chlorophenyl, or tolyl; R⁵ is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another aspect, R is methyl, or a mixture of methyl and trifluoropropyl, or a mixture of methyl and phenyl. In still another aspect, M is methoxy, n is one, R⁵ is a divalent C₁-C₃ aliphatic group, and R is methyl.

Units of formula (14) can be derived from the corresponding dihydroxy polydiorganosiloxane (15):

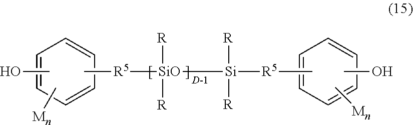

wherein R, D, M, R⁵, and n are as described above. Such dihydroxy polysiloxanes can be made by effecting a platinum catalyzed addition between a siloxane hydride of formula (16):

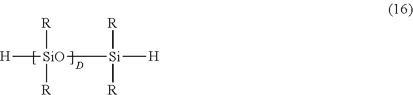

wherein R and D are as previously defined, and an aliphatically unsaturated monohydric phenol. Useful aliphatically unsaturated monohydric phenols included, for example, eugenol, 2-allylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing can also be used.

Exemplary polysiloxane-polycarbonates comprise polysiloxane units derived from dimethylsiloxane units (e.g., formula (11) where R is methyl), and carbonate units derived from bisphenol A, e.g., the dihydroxy compound of formula (3) in which each of A¹ and A² is p-phenylene and Y¹ is isopropylidene. Polysiloxane-polycarbonates can have a weight average molecular weight of 2,000 to 100,000 g/mol, specifically 5,000 to 50,000 g/mol. Some specific polysiloxane-polycarbonates have, for example, a weigh average molecular weight of 15,000 to 45,000 g/mol. Molecular weights referred to herein are as measured by gel permeation chromatography using a crosslinked styrene-divinyl benzene column, at a sample concentration of about 1 milligram per milliliter, and as calibrated with polycarbonate standards.

In various aspects, the polycarbonate-polysiloxane copolymer component is a polycarbonate-polysiloxane block copolymer. In a further aspect, the polycarbonate block of the polycarbonate-polysiloxane block copolymer comprises residues derived from BPA. In a still further aspect, the polycarbonate block of the polycarbonate-polysiloxane block copolymer is a homopolymer. In a yet further aspect, the polysiloxane block of the polycarbonate-polysiloxane block copolymer comprises dimethylsiloxane repeating units.

In various aspects, the polycarbonate-polysiloxane copolymer component comprises a polysiloxane block from about 5 wt % to about 30 wt % of the polycarbonate-polysiloxane copolymer component. In a further aspect, the polycarbonate-polysiloxane copolymer component comprises a polysiloxane block from about 10 wt % to about 25 wt % of the polycarbonate-polysiloxane copolymer component. In a still further aspect, the polycarbonate-polysiloxane copolymer component comprises a polysiloxane block from about 15 wt % to about 25 wt % of the polycarbonate-polysiloxane copolymer component. In an even further aspect, the polycarbonate-polysiloxane copolymer component comprises a polysiloxane block from about 17.5 wt % to about 22.5 wt % of the polycarbonate-polysiloxane copolymer component. In a still further aspect, the polycarbonate-polysiloxane copolymer component comprises a polysiloxane block from about 19 wt % to about 21 wt % of the polycarbonate-polysiloxane copolymer component.

In a further aspect, the polycarbonate-polysiloxane copolymer component comprises a polysiloxane block less than or equal to about 25 wt % of the polycarbonate-polysiloxane copolymer component. In a still further aspect, the polycarbonate-polysiloxane copolymer component comprises a polysiloxane block less than or equal to about 22.5 wt % of the polycarbonate-polysiloxane copolymer component. In a yet further aspect, the polycarbonate-polysiloxane copolymer component comprises a polysiloxane block less than or equal to about 20 wt % of the polycarbonate-polysiloxane copolymer component.

In a further aspect, the polycarbonate-polysiloxane copolymer is present in an amount from about 1 wt % to about 30 wt %. In a still further aspect, the polycarbonate-polysiloxane copolymer component is present from about 1 wt % to about 20 wt %. In a yet further aspect, the polycarbonate-polysiloxane copolymer is present in an amount from about 1 wt % to about 25 wt %. In an even further aspect, the polycarbonate-polysiloxane copolymer component is present in an amount from about 5 wt % to about 20 wt %. In a still further aspect, the polycarbonate-polysiloxane copolymer component is present in an amount from about 5 wt % to about 25 wt %. In a yet further aspect, the polycarbonate-polysiloxane copolymer component is present in an amount from about 5 wt % to about 30 wt %. In an even further aspect, the polycarbonate-polysiloxane copolymer component is present in an amount from about 10 wt % to about 25 wt %. In a still further aspect, the polycarbonate-polysiloxane copolymer component is present in an amount from about 10 wt % to about 20 wt %. In a yet further aspect, the polycarbonate-polysiloxane copolymer component is present in an amount from about 10 wt % to about 15 wt %. In an even further aspect, the polycarbonate-polysiloxane copolymer component is present in an amount from about 15 wt % to about 25 wt %. In a still further aspect, the polycarbonate-polysiloxane copolymer component is present in an amount from about 15 wt % to about 20 wt %.

In a further aspect, the polycarbonate-polysiloxane copolymer component comprises a blend of polycarbonate-polysiloxane copolymers.

### F. THERMALLY CONDUCTIVE FILLER

In one aspect, the blended thermoplastic compositions of the present invention comprise a thermally conductive filler. In a further aspect, the thermally conductive filler is selected from AlN, Al₄C₃, Al₂O₃, BN, AlON, MgSiN₂, SiC, Si₃N₄, graphite, expanded graphite, grapheme, carbon fiber, ZnS, CaO, MgO, ZnO, TiO₂, H₂Mg₃(SiO₃)₄, CaCO₃, Mg(OH)₂, mica, BaO, γ-AlO(OH), α-AlO(OH), Al(OH)₃, BaSO₄, CaSiO₃, ZrO₂, SiO₂, a glass bead, a glass fiber, MgO.xAl₂O₃, CaMg(CO₃)₂, and a clay, or a combinations thereof.

In a further aspect, the thermally conductive filler component comprises at least one high thermally conductive filler. In a still further aspect, the high thermally conductive filler has a conductivity greater than or equal to about 30 W/mK when determined in accordance with ASTM E1225.

Examples of high thermally conductive filler include, but are not limited to, MN (Aluminum nitride), Al₄C₃ (Aluminum carbide), Al₂O₃ (Aluminum oxide), BN (Boron nitride), AlON (Aluminum oxynitride), MgSiN₂ (Magnesium silicon nitride), SiC (Silicon carbide), Si₃N₄ (Silicon nitride), graphite, expanded graphite, graphene, and carbon fiber, or combinations thereof. In a further aspect, the high thermally conductive filler is selected from AlN, Al₄C₃, Al₂O₃, BN, AlON, MgSiN₂, SiC, Si₃N₄, graphite, expanded graphite, graphene, and carbon fiber, or combinations thereof. In a still further aspect, the high thermally conductive filler is selected from AlN, Al₂O₃, BN, SiC, graphite, expanded graphite, and carbon fiber, or combinations thereof. In yet a further aspect, the high thermally conductive filler is selected from BN, graphite, and expanded graphite, or combinations thereof.

The graphite used in the present invention can be synthetically produced or naturally produced, or can be expandable graphite or expanded graphite with a thickness smaller than 1 micron. In one aspect, the graphite is naturally produced. There are three types of naturally produced graphite that are commercially available. They are flake graphite, amorphous graphite and crystal vein graphite. In one aspect, the graphite is flake graphite, wherein the flake graphite is typically found as discrete flakes ranging in size from 10-800 micrometers in diameter and 1-150 micrometers thick and purities ranging from 80-99.9% carbon. In another aspect the graphite is spherical.

The boron nitride used in the invention is typically hexagonal boron nitride (h-BN), which can be complete h-BN or turbostratic boron nitride (t-BN). The BN particle can be large sized single BN crystal powder, agglomerate of small sized BN particles, the mixture thereof, the agglomerated spherical powder, or BN fiber. In one aspect, the BN average particle size or D50 in diameter can range from 1 to 500 micrometers. In another aspect, within this range, the boron nitride particles have a size of greater than or equal to about 3, or greater than or equal to about 5 micrometers. The particle size indicated here means the single BN particle or its agglomerate at any of their dimensions. In one aspect, the BN has a BN purity ranging from 95% to 99.8%. In one aspect, a large single crystal sized flake BN with an average size ranging from 3 to 50 micrometer and a BN purity of over 98% is used.

In a further aspect, the thermally conductive filler component comprises at least one intermediate thermally conductive filler. In a further aspect, the intermediate thermally conductive filler component has a conductivity from about 10 W/mK to about 30 W/mK when determined in accordance with ASTM E1225.

Examples of intermediate thermally conductive fillers include, but are not limited to, ZnS, CaO, MgO, ZnO, and TiO₂, or combinations thereof. In a further aspect, the intermediate thermally conductive filler is TiO₂.

In a further aspect, the thermally conductive filler component comprises at least one low thermally conductive filler. In a further aspect, the low thermally conductive filler component has a conductivity less than about 10 W/mK when determined in accordance with ASTM E1225.

Examples of low thermally conductive fillers include, but are not limited to, H₂Mg₃(SiO₃)₄, CaCO₃, Mg(OH)₂, mica, BaO, γ-AlO(OH), α-AlO(OH), Al(OH)₃, BaSO₄, CaSiO₃, ZrO₂, SiO₂, a glass bead, a glass fiber, MgO.xAl₂O₃, CaMg(CO₃)₂, and clay). In a further aspect, the low thermally conductive filler is selected from H₂Mg₃(SiO₃)₄, Mg(OH)₂, γ-AlO(OH), α-AlO(OH), and Al(OH)₃, or combinations thereof. In a still further aspect, the low thermally conductive filler is selected from H₂Mg₃(SiO₃)₄, γ-AlO(OH), α-AlO(OH), and Al(OH)₃, or combinations thereof. In yet a further aspect, the low thermally conductive filler is H₂Mg₃(SiO₃)₄.

In a further aspect, the thermally conductive filler component is present in an amount from about 1 wt % to about 50 wt %. In a still further aspect, the thermally conductive filler component is present in an amount from about 10 wt % to about 50 wt %. In yet a further aspect, the thermally conductive filler component is present in an amount from about 20 wt % to about 40 wt %. In an even further aspect, the thermally conductive filler is present in an amount from about 5 wt % to about 50 wt %. In a still further aspect, the thermally conductive filler is present in an amount from about 5 wt % to about 45 wt %. In yet a further aspect, the thermally conductive filler is present in an amount from about 5 wt % to about 30 wt %.

In a further aspect, the thermally conductive filler component comprises at least one intermediate thermally conductive filler, wherein the intermediate thermally conductive filler component has a conductivity from about 10 W/mK to about 30 W/mK when determined in accordance with ASTM E1225, and at least one low thermally conductive filler, wherein the low thermally conductive filler component has a conductivity less than about 10 W/mK when determined in accordance with ASTM E1225.

In a further aspect, the thermally conductive filler component comprising at least one intermediate thermally conductive filler and at least one low thermally conductive filler is present in an amount from about 1 wt % to about 50 wt %. In a still further aspect, the thermally conductive filler component comprising at least one intermediate thermally conductive filler and at least one low thermally conductive filler is present in an amount from about 10 wt % to about 50 wt %.

In a further aspect, the thermally conductive filler component comprising at least one intermediate thermally conductive filler and at least one low thermally conductive filler, wherein the intermediate thermally conductive filler is present in an amount from about 5 wt % to about 20 wt %, and wherein the low thermally conductive filler is present in an amount from about 5 wt % to about 20 wt %. In a still further aspect, the thermally conductive filler component comprising at least one intermediate thermally conductive filler and at least one low thermally conductive filler, wherein the intermediate thermally conductive filler is present in an amount from about 10 wt % to about 20 wt %, and wherein the low thermally conductive filler is present in an amount from about 10 wt % to about 20 wt %. In a yet further aspect, the thermally conductive filler component comprising at least one intermediate thermally conductive filler and at least one low thermally conductive filler, wherein the intermediate thermally conductive filler is present in an amount from about 15 wt % to about 20 wt %, and wherein the low thermally conductive filler is present in an amount from about 15 wt % to about 20 wt %.

In a further aspect, the thermally conductive filler comprises TiO₂ and H₂Mg₃(SiO₃)₄.

In various aspects, the thermally conductive filler comprises TiO₂ and H₂Mg₃(SiO₃)₄, present together in an amount from about 1 wt % to about 50 wt %. In a further aspect, the thermally conductive filler comprises TiO₂ and H₂Mg₃(SiO₃)₄, present together in an amount from about 10 wt % to about 50 wt %.

In various aspects, the thermally conductive filler comprises TiO₂ and H₂Mg₃(SiO₃)₄, wherein the TiO₂ is present in an amount from about 5 wt % to about 20 wt % and wherein the H₂Mg₃(SiO₃)₄ is present in an amount in an amount from about 5 wt % to about 20 wt %. In a further aspect, the thermally conductive filler comprises TiO₂ and H₂Mg₃(SiO₃)₄, wherein the TiO₂ is present in an amount from about 10 wt % to about 20 wt % and wherein the H₂Mg₃(SiO₃)₄ is present in an amount in an amount from about 10 wt % to about 20 wt %. In a still further aspect, the thermally conductive filler comprises TiO₂ and H₂Mg₃(SiO₃)₄, wherein the TiO₂ is present in an amount from about 15 wt % to about 20 wt % and wherein the H₂Mg₃(SiO₃)₄ is present in an amount in an amount from about 15 wt % to about 20 wt %.

### G. OPTIONAL POLYESTER COMPONENT

In various aspects, the disclosed polymer compositions further comprise a polyester polymer component. In a further aspect, the polyester polymer is polybutylene terephthalate, alternatively referred to as poly(1,4-butylene terephthalate) or PBT. In a still further aspect, the polyester polymer is polyethylene terephthalate, alternatively referred to as poly(ethylene terephthalate) or PET.

In a further aspect, the polyester polymer component is present in an amount great than about 0 wt % to about 20 wt %. In a still further aspect, the polyester polymer component is present in an amount great than about 0 wt % to about 10 wt %. In yet a further aspect, the polyester polymer component is present in an amount great than about 1 wt % to about 20 wt %. In an even further aspect, the polyester polymer component is present in an amount great than about 1 wt % to about 10 wt %. In a still further aspect, the polyester polymer component is present in an amount great than about 5 wt % to about 15 wt %.

In a further aspect, the polycondensation of terephthalic acid and ethylene glycol by an ester exchange reaction or direct esterification reaction can be used to prepare a suitable PET for use in the disclosed blended polycarbonate compositions. In a still further aspect, PET can be prepared by the esterification of ethylene glycol and terephthalic acid or by the ester interchange of dimethyl terephthalate with ethylene glycol, followed by polycondensation in the presence of a catalyst such as antimony trioxide, at a temperature of about 285° C. and at a pressure of about 1 millimeter of mercury. The PET reaction product can then be extruded at a temperature of about 285° C. and a pressure of one atmosphere into water and allowed to solidify therein. The solid PET can then be pelletized by means known to those skilled in this art. For example, the PET can be pelletized using an underwater pelletizer. It is known that the intrinsic viscosity of PET can be increased by solid state polymerization in the presence of an inert gas such as nitrogen (see, e.g., U.S. Pat. No. 4,064,112).

It should be noted that the terms “polyethylene terephthalate” and “PET” as used herein are meant to include PET no matter how prepared. Furthermore, these terms are meant to include polyethylene terephthalate polymers which are reacted with minor, e.g., less than about 20 percent by weight of the polymer, amounts of modifying agents. Such modifying agents include various diols such as 1,4 butane diol, cyclohexane dimethanol and 1,3 propane diol. Other modifying agents include various diacids such as isophthalic acid, adipic acid, 2,6 naphthalene dicarboxylic acid and p-hydroxy benzoic acid. Minor amounts of chain branching agents and/or chain terminating agents can also be used. Such chain branching agents include, for example, polyfunctional acids and/or polyfunctional alcohols such as trimethylol propane and pentaerythritol. Chain terminating agents include monofunctional alcohols and/or monofunctional carboxylic acids such as stearic acid and benzoic acid. Mixtures of the chain branching and chain terminating agents can also be used. PET which contains such chain branching agents and chain terminating agents is described in U.S. Pat. No. 4,161,579.

### H. OPTIONAL IMPACT MODIFIER

In various aspects, the disclosed polymer compositions further comprise an impact modifier polymer component. In a further aspect, the impact modifier component comprises at least one acrylonitrile-butadiene-styrene (ABS) polymer, at least one bulk polymerized ABS (BABS) polymer, or at least one methyl methacrylate-butadiene-styrene (MBS) polymer. In a still further aspect, the impact modifier component comprises a methyl methacrylate-butadiene-styrene (MBS) polymer. In yet a further aspect, the impact modifier component comprises an acrylonitrile-butadiene-styrene (ABS) polymer composition.

In a further aspect, the ABS polymer composition is a bulk-polymerized ABS. In a still further aspect, the ABS polymer composition is a SAN-grafted emulsion ABS.

In a further aspect, the impact modifier is present in an amount greater than 0 wt % to about 30 wt %. In a still further aspect, the impact modifier is present in an amount greater than 0 wt % to about 20 wt %. In yet a further aspect, the impact modifier is present in an amount greater than 0 wt % to about 10 wt %. In an even further aspect, the impact modifier is present in an amount greater than about 1 wt % to about 10 wt %. In a still further aspect, the impact modifier is present in an amount greater than about 5 wt % to about 15 wt %.

### I. OPTIONAL REINFORCING FILLER

In various aspects, the disclosed blended thermoplastic compositions further comprise a reinforcing component to increase the stiffness (e.g. modulus and tensile strength). Examples of suitable fillers or reinforcing agents include any materials known for these uses, provided that they do not adversely affect the desired properties. For example, suitable fillers and reinforcing agents include silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dehydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide, or the like; barium compounds such as barium titanate, barium ferrite, barium sulfate, heavy spar, or the like; metals and metal oxides such as particulate or fibrous aluminum, bronze, zinc, copper and nickel, or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as kenaf, cellulose, cotton, sisal, jute, flax, starch, corn flour, lignin, ramie, rattan, agave, bamboo, hemp, ground nut shells, corn, coconut (coir), rice grain husks or the like; organic fillers such as polytetrafluoroethylene, reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, Tripoli, diatomaceous earth, carbon black, or the like, or combinations comprising at least one of the foregoing fillers or reinforcing agents. In a still further aspect, the filler is talc, glass fiber, kenaf fiber, or combinations thereof. In yet a further aspect, the filler is glass fiber. The fillers and reinforcing agents can be coated with a layer of metallic material to facilitate conductivity, or surface treated with silanes, siloxanes, or a combination of silanes and siloxanes to improved adhesion and dispersion with the polymeric matrix resin.

In a further aspect, the reinforcing filler is selected from glass beads, glass fiber, glass flakes, mica, talc, clay, wollastonite, zinc sulfide, zinc oxide, carbon fiber, ceramic-coated graphite, and titanium dioxide. In a still further aspect, the reinforcing filler is a glass fiber. In yet a further aspect, the glass fiber is continuous. In an even further aspect, the glass fiber is chopped.

In a further aspect, the glass fiber has a round, flat, or irregular cross-section. In a still further aspect, the glass fiber has a round cross-section. In a still further aspect, the glass fiber has a diameter from about 4 μm to about 15 μm.

In a further aspect, the glass fiber would be surface treated by amino silane, wax, and epoxy silane, or a mixture thereof. In a still further aspect, the glass fiber would be non-surface treated.

In a further aspect, the reinforcing fillers can be provided in the form of monofilament or multifilament fibers and can be used either alone or in combination with other types of fiber, for example, co-weaving or core/sheath, side-by-side, orange-type or matrix and fibril constructions, or by other methods known to one skilled in the art of fiber manufacture. Suitable co-woven structures include, for example, glass fiber-carbon fiber, carbon fiber-aromatic polyimide (aramid) fiber, and aromatic polyimide fiberglass fiber or the like. Fibrous fillers can be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids.

In various aspects, the reinforcing fillers can be surface-treated with a surface treatment agent containing a coupling agent. Suitable coupling agents include, but are not limited to, silane-based coupling agents, or titanate-based coupling agents, or a mixture thereof. Applicable silane-based coupling agents include aminosilane, epoxysilane, amidosilane, azidosilane and acrylsilane.

In a further aspect, the reinforcing filler is particulate.

In a further aspect, the reinforcing filler is fibrous. In a still further aspect, the fibrous filler has a circular cross-section. In yet a further aspect, the fibrous filler has a non-circular cross-section.

In a further aspect, the reinforcing filler is present in an amount greater than 0 wt % to about 50 wt %. In a still further aspect, the reinforcing filler is present in an amount greater than 0 wt % to about 40 wt %. In a yet further aspect, the reinforcing filler is present in an amount greater than 0 wt % to about 30 wt %. In an even further aspect, the reinforcing filler is present in an amount greater than 0 wt % to about 25 wt %. In a still further aspect, the reinforcing filler is present in an amount greater than 0 wt % to about 20 wt %. In a still further aspect, the reinforcing filler is present in an amount greater than 0 wt % to about 15 wt %.

### J. OPTIONAL FLAME RETARDANT

In various aspects, the disclosed polymer compositions further comprise at least one flame retardant, wherein the flame retardant can comprise any flame retardant material or mixture of flame retardant materials suitable for use in the inventive polymer compositions. In various aspects, the flame retardant is a phosphorus-containing flame retardant. In a further aspect, the flame retardant is selected from oligomeric phosphate flame retardant, polymeric phosphate flame retardant, an aromatic polyphosphate flame retardant, oligomeric phosphonate flame retardant, phenoxyphosphazene oligomeric flame retardant, or mixed phosphate/phosphonate ester flame retardant compositions. In a still further aspect, the flame retardant comprises a halogen containing material. In a yet further aspect, the flame retardant is free of or substantially free of one or more of phosphate and/or a halogen. In an even further aspect, the flame retardant is free of or substantially free of a halogen.

In a further aspect, the blended thermoplastic compositions further comprise a flame retardant selected from organic compounds that include phosphorous, bromine, and/or chlorine. Non-brominated and non-chlorinated phosphorous-containing compounds can be preferred in certain applications for regulatory reasons, for example, organic phosphates and organic compounds containing phosphorous-nitrogen bonds. Exemplary organic phosphates can include an aromatic phosphate of the formula (GO)₃P═O, wherein each G is independently an alkyl, cycloalkyl, aryl, alkaryl, or aralkyl group, provided that at least one G is an aromatic group. Two of the G groups can be joined together to provide a cyclic group, for example, diphenyl pentaerythritol diphosphate, which is described by Axelrod in U.S. Pat. No. 4,154,775. Other suitable aromatic phosphates can be, for example, phenyl bis(dodecyl)phosphate, phenyl bis(neopentyl)phosphate, phenyl bis(3,5,5′-trimethylhexyl)phosphate, ethyl diphenyl phosphate, 2-ethylhexyl di(p-tolyl)phosphate, bis(2-ethylhexyl)p-tolyl phosphate, tritolyl phosphate, bis(2-ethylhexyl)phenyl phosphate, dibutyl phenyl phosphate, 2-chloroethyl diphenyl phosphate, p-tolyl bis(2,5,5′-trimethylhexyl)phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like.

In a further aspect, di- or polyfunctional aromatic phosphorous-containing compounds can also be present. Examples of suitable di- or polyfunctional aromatic phosphorous-containing compounds include triphenyl phosphate (TPP), resorcinol tetraphenyl diphosphate (RDP), the bis(diphenyl)phosphate of hydroquinone and the bis(diphenyl)phosphate of bisphenol-A, respectively, their oligomeric and polymeric counterparts, and the like.

In a further aspect, organic phosphates and organic compounds containing phosphorous-nitrogen bonds can also be present. For example, phosphonitrilic chloride, phosphorous ester amides, phosphoric acid amides, phosphonic acid amides, phosphinic acid amides, tris(aziridinyl)phosphine oxide, or the like. In one aspect, [phenoxyphosphazene] is used as a flame retardant.

Exemplary flame retardants include aromatic cyclic phosphazenes having a structure represented by the formula:

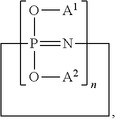

wherein each of A¹ and A² is independently an aryl group having 6 to 10 carbon atoms substituted with 0 to 4 C1-C4 alkyl groups; and n is an integer of 3 to 6. The aryl group of A¹ and A² means an aromatic hydrocarbon group having 6 to 10 atoms. Examples of such groups include phenyl and naphthyl groups. In a further aspect, the aryl group of A¹ and A² is independently selected from phenyl and naphthyl. In a still further aspect, the aryl group of A¹ and A² is phenyl. In a further aspect, aromatic cyclic phosphazene compound is a mixture of compounds represented by the foregoing formula, comprising a mixture of compounds with n=3, n=4, n=5, and n=6.

The “aryl group having 6 to 10 carbon atoms” can be substituted with 0 to 4 C1-C4 alkyl groups, wherein the alkyl group means a straight or branched saturated hydrocarbon group having 1 to 4 carbon atoms. Examples of the group include a methyl group, an ethyl group, a propyl group, an isopropyl group, a butyl group, an isobutyl group, a sec-butyl group, and a tert-butyl group. In various further aspects, the alkyl group has 1 to 3 carbon atoms. In a still further aspect, the alkyl group is methyl.

In a further aspect, each of A¹ and A² is a phenyl group, wherein each of A¹ and A² is independently substituted with 0 to 4 C1-C4 alkyl groups. In a still further aspect, each of A¹ and A² is a phenyl group, wherein each of A¹ and A² is independently substituted with 0 to 4 C1-C3 alkyl groups. In a yet further aspect, each of A¹ and A² is a phenyl group independently substituted with 0 to 4 methyl groups. In an even further aspect, each of A¹ and A² is independently selected from phenyl, o-tolyl, p-tolyl, and m-tolyl.

In various further aspects, three to six A¹ groups are present, wherein each A¹ group can be the same as or different from each other. In a further aspect, three to six A¹ groups are present, wherein each A¹ group is the same.

In various further aspects, three to six A² groups are present, wherein each A² group can be the same as or different from each other. In a further aspect, three to six A² groups are present, wherein each A² group is the same. In a yet further aspect, each A¹ and each A² are the same moiety.

In a further aspect, aromatic cyclic phosphazenes useful in the present invention are compounds having a structure represented by the formula:

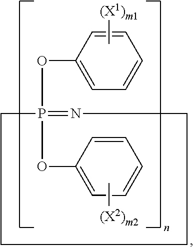

wherein each occurrence of X¹ and X² is independently a C1-C4 alkyl group; wherein each of m1 and m2 is independently an integer of 0 to 4; and wherein n is an integer of 3 to 6. As described above, alkyl group means a straight or branched saturated hydrocarbon group having 1 to 4 carbon atoms. Examples of the group include a methyl group, an ethyl group, a propyl group, an isopropyl group, a butyl group, an isobutyl group, a sec-butyl group, and a tert-butyl group. In various further aspects, the alkyl group has 1 to 3 carbon atoms. In a still further aspect, the alkyl group is methyl. In a further aspect, each of m1 and m2 is independently an integer of 0 to 3. In a still further aspect, each of m1 and m2 is independently an integer of 0 to 2. In a yet further aspect, each of m1 and m2 is independently an integer that is 0 or 1. In an even further aspect, each of m1 and m2 is 0. In a still further aspect, each of m1 and m2 is 1.

In various further aspects, three to six X¹ groups are present, wherein each X¹ group can be the same as or different from each other. In a further aspect, three to six X¹ groups are present, wherein each X¹ group is the same.

In various further aspects, three to six X² groups are present, wherein each X² group can be the same as or different from each other. In a further aspect, three to six X² groups are present, wherein each X² group is the same. In a yet further aspect, each X¹ and each X² are the same moiety.

In various further aspects, the aromatic cyclic phosphazene is a compound selected from Examples of the compound represented by General Formula (1) include 2,2,4,4,6,6-hexaphenoxycyclotriphosphazene, 2,2,4,4,6,6-hexakis(p-tolyloxy)cyclotriphosphazene, 2,2,4,4,6,6-hexakis(m-tolyloxy)cyclotriphosphazene, 2,2,4,4,6,-hexakis(o-tolyloxy)cyclotriphosphazene, 2,4,6-triphenoxy-2,4,6-tris(p-tolyloxy)cyclotriphosphazene, 2,4,6-triphenoxy-2,4,6-tris(m-tolyloxy)cyclotriphosphazene, 2,4,6-triphenoxy-2,4,6-tris(o-tolyloxy)cyclotriphosphazene, 2,4,6-triphenoxy-2,4,6-tris(2-ethylphenoxy)cyclotriphosphazene, 2,4,6-triphenoxy-2,4,6-tris(3-ethylphenoxy)cyclotriphosphazene, 2,4,6-triphenoxy-2,4,6-tris(4-ethylphenoxy)cyclotriphosphazene, 2,4,6-triphenoxy-2,4,6-tris(2,3-xylyloxy)cyclotriphosphazene, 2,4,6-triphenoxy-2,4,6-tris(2,4-xylyloxy)cyclotriphosphazene, 2,4,6-triphenoxy-2,4,6-tris(2,5-xylyloxy)cyclotriphosphazene, 2,4,6-triphenoxy-2,4,6-tris(2,6-xylyloxy)cyclotriphosphazene, 2,4,6-triphenoxy-2,4,6-tris(3,4-xylyloxy)cyclotriphosphazene, 2,4,6-triphenoxy-2,4,6-tris(3,5-xylyloxy)cyclotriphosphazene, 2,2,4,4,6,6,8,8-octaphenoxycyclotetraphosphazene, 2,2,4,4,6,6,8,8-octakis(p-tolyloxy)cyclotetraphosphazene, 2,2,4,4,6,6,8,8-octakis(m-tolyloxy)cyclotetraphosphazene, 2,2,4,4,6,6,8,8-octakis(o-tolyloxy)cyclotetraphosphazene, 2,4,6,8-tetraphenoxy-2,4,6,8-tetrakis(p-tolyloxy)cyclotetraphosphazene, 2,4,6,8-tetraphenoxy-2,4,6,8-tetrakis(m-tolyloxy)cyclotetraphosphazene, and 2,4,6,8-tetraphenoxy-2,4,6,8-tetrakis(o-tolyloxy)cyclotetraphosphazene. In a still further aspect, the aromatic cyclic phosphazene is selected from 2,2,4,4,6,6-hexaphenoxycyclotriphosphazene, 2,4,6-triphenoxy-2,4,6-tris(p-tolyloxy)cyclotriphosphazene, 2,4,6-triphenoxy-2,4,6-tris(m-tolyloxy)cyclotriphosphazene, and 2,4,6-triphenoxy-2,4,6-tris(o-tolyloxy)cyclotriphosphazene.

In a further aspect, the aromatic cyclic phosphazene at least one compound represented by one of the phosphazene formulas described herein as a main component. In various aspects, the content of the aromatic cyclic phosphazene composition is about 90 wt %. In a further aspect, the content of the aromatic cyclic phosphazene composition is about 95 wt %. In a still further aspect, the content of the aromatic cyclic phosphazene composition is about 100 wt %.

Other components in the aromatic cyclic phosphazene composition are not specifically limited as long as the object of the present invention is not impaired.

Aromatic cyclic phosphazene-containing flame retardant useful in the present invention are commerically available. Suitable examples of such commercial products include “Rabitle FP-110” and “Rabitle FP-390” manufactured by FUSHIMI Pharmaceutical Co., Ltd. In a further aspect, the phosphorus-containing flame retardant is selected from a phosphine, a phosphine oxide, a bisphosphine, a phosphonium salt, a phosphinic acid salt, a phosphoric ester, and a phosphorous ester.

In a further aspect, the flame retardant is selected from rescorcinol bis(diphenyl phosphate), resorcinol bis(dixylenyl phosphate), hydroquinone bis(diphenyl phosphate), bisphenol-A bis(diphenyl phosphate), 4,4′-biphenol bis(diphenyl phosphate), triphenyl phosphate, methylneopentyl phosphite, pentaerythritol diethyl diphosphite, methyl neopentyl phosphonate, phenyl neopentyl phosphate, pentaerythritol diphenyldiphosphate, dicyclopentyl hypodiphosphate, dineopentyl hypophosphite, phenylpyrocatechol phosphite, ethylpyrocatechol phosphate and dipyrocatechol hypodiphosphate. In a still further aspect, the flame retardant is selected from triphenyl phosphate; cresyldiphenylphosphate; tri(isopropylphenyl)phosphate; resorcinol bis(diphenylphosphate); and bisphenol-A bis(diphenyl phosphate). In a yet further aspect, the flame retardant is selected from resorcinol bis(biphenyl phosphate), bisphenol A bis(diphenyl phosphate) hydroquinone bis(diphenyl phosphate), phosphoric acid, 1,3-phenylene tetraphenyl ester), bis-phenol-A bis-diphenyl phosphate) or mixtures thereof. In a still further aspect, the flame retardant is selected from resorcinol bis(biphenyl phosphate), bisphenol A bis(diphenyl phosphate), and hydroquinone bis(diphenyl phosphate), or mixtures thereof. In yet a further aspect, the flame retardant is bisphenol A bis(diphenyl phosphate). In an even further aspect, the phosphorus-containing flame retardant is resorcinol bis(biphenyl phosphate).

In various aspects, the flame retardant is present in an amount less than or equal to about 25 wt %. In a further aspect, the flame retardant is present in an amount less than or equal to about 20 wt %. In a still further aspect, the flame retardant is present in an amount less than or equal to about 15 wt %. In a yet further aspect, the flame retardant is present in an amount less than or equal to about 10 wt %.

In a further aspect, the flame retardant is present in an amount from about 10 wt % to about 25 wt %. In a still further aspect, the flame retardant is present in an amount from about 10 wt % to about 20 wt %. In yet a further aspect, the flame retardant is present in an amount from about 10 wt % to about 15 wt %.

In a further aspect, the flame retardant is present in an amount from about 5 wt % to about 25 wt %. In a still further aspect, the flame retardant is present in an amount from about 5 wt % to about 20 wt %. In yet a further aspect, the flame retardant is present in an amount from about 5 wt % to about 15 wt %. In an even further aspect, the flame retardant is present in an amount from about 5 wt % to about 14 wt %. In a still further aspect, the flame retardant is present in an amount from about 5 wt % to about 13 wt %. In yet a further aspect, the flame retardant is present in an amount from about 5 wt % to about 12 wt %. In an even further aspect, the flame retardant is present in an amount from about 5 wt % to about 11 wt %. In a still further aspect, the flame retardant is present in an amount from about 5 wt % to about 10 wt %.

In a further aspect, the flame retardant is present in an amount from about 3 wt % to about 25 wt %. In a still further aspect, the flame retardant is present in an amount from about 3 wt % to about 20 wt %. In yet a further aspect, the flame retardant is present in an amount from about 3 wt % to about 15 wt %. In an even further aspect, the flame retardant is present in an amount from about 3 wt % to about 14 wt %. In a still further aspect, the flame retardant is present in an amount from about 3 wt % to about 13 wt %. In yet a further aspect, the flame retardant is present in an amount from about 3 wt % to about 12 wt %. In an even further aspect, the flame retardant is present in an amount from about 3 wt % to about 11 wt %. In a still further aspect, the flame retardant is present in an amount from about 3 wt % to about 10 wt %.

### K. OPTIONAL ADDITIVES

The disclosed polymer compositions can further comprise at least one additive conventionally used in the manufacture of molded thermoplastic parts with the proviso that the optional additives do not adversely affect the desired properties of the resulting composition. Mixtures of optional additives can also be used. Such additives can be mixed at a suitable time during the mixing of the components for forming the composite mixture. In one aspect, the disclosed compositions can comprise one or more additives selected from an anti-drip agent, antioxidant, antistatic agent, chain extender, colorant, de-molding agent, dye, flow promoter, flow modifier, light stabilizer, lubricant, mold release agent, pigment, quenching agent, thermal stabilizer, UV absorbent substance, UV reflectant substance, and UV stabilizer, or combinations thereof. In one aspect, the composition further comprises one or more optional additives selected from an antioxidant and stabilizer.

Exemplary anti-drip agents include, for example, a fibril forming or non-fibril forming fluoropolymer such as polytetrafluoroethylene (PTFE). In a further aspect, the anti-drip agent is a styrene-acrylonitrile copolymer encapsulated polytetrafluoroethylene.

In a further aspect, the anti-drip agent is present in an amount from about 0.05 wt % to about 3 wt %. In a still further aspect, the anti-drip agent is present in an amount from about 0.1 wt % to about 2 wt %. In yet a further aspect, the anti-drip agent is present in an amount from about 0.1 wt % to about 1 wt %.

Exemplary flow promoters include, for example, polyamide flow promoters such as nylon and polyphthalimide.

In a further aspect, the flow promoter is present in an amount from about 0 wt % to about 5 wt %. In a still further aspect, the flow promoter is present in an amount from about 0 wt % to about 4 wt %. In yet a further aspect, the flow promoter is present in an amount from about 0 wt % to about 3 wt %.

In various aspects, the invention further comprises one or more de-molding agents. In a further aspect, the de-molding agent is present in an amount from about 0 wt % to about 5 wt %. In a still further aspect, the de-molding agent is present in an amount from about 0 wt % to about 4 wt %. In yet a further aspect, the de-molding agent is present in an amount from about 0 wt % to about 3 wt %.

Exemplary heat stabilizers include, for example, organophosphites such as triphenylphosphite, tris-(2,6-dimethylphenyl)phosphite, tris-(mixed mono- and di-nonylphenyl)phosphite or the like; phosphonates such as dimethylbenzenephosphonate or the like, phosphates such as trimethyl phosphate, or the like, or combinations including at least one of the foregoing heat stabilizers. Heat stabilizers are generally used in amounts of from 0.01 to 0.5 parts by weight based on 100 parts by weight of the total composition, excluding any filler.

In a further aspect, the heat stabilizer is present in an amount from about 0 wt % to about 5 wt %. In a still further aspect, the heat stabilizer is present in an amount from about 0 wt % to about 4 wt %. In yet a further aspect, the heat stabilizer is present in an amount from about 0 wt % to about 3 wt %.

In various aspects, the invention further comprises an antioxidant. Exemplary antioxidants include, for example, organophosphites such as tris(nonyl phenyl)phosphite, tris(2,4-di-t-butylphenyl)phosphite, bis(2,4-di-t-butylphenyl)pentaerythritoldiphosphite, distearylpentaerythritoldiphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylatedthiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations including at least one of the foregoing antioxidants. Antioxidants are generally used in amounts of from 0.01 to 0.5 parts by weight, based on 100 parts by weight of the total composition, excluding any filler.

In a further aspect, the antioxidant is a primary antioxidant, a secondary antioxidant, or combinations thereof.

In a further aspect, the primary antioxidant is selected from a hindered phenol and secondary aryl amine, or a combination thereof. In a still further aspect, the hindered phenol comprises one or more compounds selected from triethylene glycol bis[3-(3-t-butyl-5-methyl-4-hydroxyphenyl)propionate], 1,6-hexanediol bis[3-(3,5-di-t-butyl-4-hydroxyphenyl)propionate], 2,4-bis(n-octylthio)-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl 3-(3,5-di-t-butyl-4-hydroxyphenyl)propionate, N,N′-hexamethylene bis(3,5-di-t-butyl-4-hydroxy-hydrocinnamamide), tetrakis(methylene 3,5-di-tert-butyl-hydroxycinnamate)methane, and octadecyl 3,5-di-tert-butylhydroxyhydrocinnamate. In yet a further aspect, the hindered phenol comprises octadecyl-3-(3,5-di-t-butyl-4-hydroxyphenyl)-propionate.

In a further aspect, the primary anti-oxidant is present in an amount from about 0.01 wt % to about 0.50 wt %. In a still further aspect, the primary anti-oxidant is present in an amount from about 0.01 wt % to about 0.20 wt %. In yet a further aspect, the primary anti-oxidant is present in an amount from about 0.01 wt % to about 0.10 wt %.

In a further aspect, the secondary anti-oxidant is selected from an organophosphate and thioester, or a combination thereof. In a still further aspect, the secondary anti-oxidant comprises one or more compounds selected from tetrakis(2,4-di-tert-butylphenyl) [1,1-biphenyl]-4,4′-diylbisphosphonite, tris(2,4-di-tert-butylphenyl) phosphite, bis(2,4-di-tert-butylphenyl)pentaerythritol diphosphite, bis(2,4-dicumylphenyl)pentaerytritoldiphosphite, tris(nonyl phenyl)phosphite, and distearyl pentaerythritol diphosphite. In a still further aspect, the secondary anti-oxidant comprises tris(2,4-di-tert-butylphenyl) phosphite.

In a further aspect, the secondary anti-oxidant is present in an amount from about 0.01 wt % to about 0.50 wt %. In a still further aspect, the secondary anti-oxidant is present in an amount from about 0.01 wt % to about 0.20 wt %. In yet a further aspect, the secondary anti-oxidant is present in an amount from about 0.01 wt % to about 0.10 wt %.

Exemplary light stabilizers include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers are generally used in amounts of from 0.1 to 1.0 parts by weight, based on 100 parts by weight of the total composition, excluding any filler.

In a further aspect, the light stabilizer is present in an amount from about 0 wt % to about 5 wt %. In a still further aspect, the light stabilizer is present in an amount from about 0 wt % to about 4 wt %. In yet a further aspect, the light stabilizer is present in an amount from about 0 wt % to about 3 wt %.

In various aspects, the invention further comprises a mold release agent. Exemplary mold releasing agents include for example, metal stearate, stearyl stearate, pentaerythritoltetrastearate, beeswax, montan wax, paraffin wax, or the like, or combinations including at least one of the foregoing mold release agents. In a further aspect, the mold release agent is an alkyl carboxylic acid ester. In a still further aspect, the alkyl carboxylic acid ester is selected from pentaerythritol tetrastearate, glycerin tristearate and ethylene glycol distearate. In yet a further aspect, the alkyl carboxylic acid ester is pentaerythritol tetrastearate.

Mold releasing agents are generally used in amounts of from 0.1 to 1.0 parts by weight, based on 100 parts by weight of the total composition, excluding any filler. In a further aspect, the mold release agent is present in an amount from about 0.05 wt % to about 1.0 wt %. In a still further aspect, the mold release agent is present in an amount from about 0.05 wt % to about 0.75 wt %. In yet a further aspect, the mold release agent is present in an amount from about 0.05 wt % to about 0.50 wt %. In an even further aspect, the mold release agent is present in an amount from about 0.05 wt % to about 0.30 wt %.

Exemplary plasticizers include, for example, phthalic acid esters such as dioctyl-4,5-epoxy-hexahydrophthalate, tris-(octoxycarbonylethyl) isocyanurate, tristearin, epoxidized soybean oil or the like, or combinations including at least one of the foregoing plasticizers. Plasticizers are generally used in amounts of from 0.5 to 3.0 parts by weight, based on 100 parts by weight of the total composition, excluding any filler.

Exemplary antistatic agents include, for example, glycerol monostearate, sodium stearylsulfonate, sodium dodecylbenzenesulfonate or the like, or combinations of the foregoing antistatic agents. In one aspect, carbon fibers, carbon nanofibers, carbon nanotubes, carbon black, or any combination of the foregoing can be used in a polymeric resin containing chemical antistatic agents to render the composition electrostatically dissipative.

Exemplary UV absorbers include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORBT™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenylacryloyl)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of from 0.01 to 3.0 parts by weight, based on 100 parts by weight of the total composition, excluding any filler.

In a further aspect, the UV absorber is present in an amount from about 0 wt % to about 5 wt %. In a still further aspect, the UV absorber is present in an amount from about 0 wt % to about 4 wt %. In yet a further aspect, the UV absorber is present in an amount from about 0 wt % to about 3 wt %.

In various aspects, the invention further comprises one or more UV stabilizers. In a further aspect, the UV stabilizer is present in an amount from about 0 wt % to about 5 wt %. In a still further aspect, the UV stabilizer is present in an amount from about 0 wt % to about 4 wt %. In yet a further aspect, the UV stabilizer is present in an amount from about 0 wt % to about 3 wt %.

Exemplary lubricants include for example, fatty acid esters such as alkyl stearyl esters, e.g., methyl stearate or the like; mixtures of methyl stearate and hydrophilic and hydrophobic surfactants including polyethylene glycol polymers, polypropylene glycol polymers, and copolymers thereof e.g., methyl stearate and polyethylene-polypropylene glycol copolymers in a suitable solvent; or combinations including at least one of the foregoing lubricants. Lubricants are generally used in amounts of from 0.1 to 5 parts by weight, based on 100 parts by weight of the total composition, excluding any filler.

Exemplary blowing agents include for example, low boiling halohydrocarbons and those that generate carbon dioxide; blowing agents that are solid at room temperature and when heated to temperatures higher than their decomposition temperature, generate gases such as nitrogen, carbon dioxide, ammonia gas, such as azodicarbonamide, metal salts of azodicarbonamide, 4,4′ oxybis(benzenesulfonylhydrazide), sodium bicarbonate, ammonium carbonate, or the like, or combinations including at least one of the foregoing blowing agents. Blowing agents are generally used in amounts of from 1 to 20 parts by weight, based on 100 parts by weight of the total composition, excluding any filler.

Exemplary pigments include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; or combinations comprising at least one of the foregoing pigments.

In a further aspect, the pigment is present in an amount from about 0 wt % to about 5 wt %. In a still further aspect, the pigment is present in an amount from about 0 wt % to about 4 wt %. In yet a further aspect, the pigment is present in an amount from about 0 wt % to about 3 wt %.

Additionally, materials to improve flow and other properties can be added to the composition, such as low molecular weight hydrocarbon resins. Particularly useful classes of low molecular weight hydrocarbon resins are those derived from petroleum C₅ to C₉ feedstock that are derived from unsaturated C₅ to C₉ monomers obtained from petroleum cracking. Non-limiting examples include olefins, e.g., pentenes, hexenes, heptenes and the like; diolefins, e.g., pentadienes, hexadienes and the like; cyclic olefins and diolefins, e.g., cyclopentene, cyclopentadiene, cyclohexene, cyclohexadiene, methyl cyclopentadiene and the like; cyclic diolefindienes, e.g., dicyclopentadiene, methylcyclopentadiene dimer and the like; and aromatic hydrocarbons, e.g., vinyltoluenes, indenes, methylindenes and the like. The resins can additionally be partially or fully hydrogenated.

### L. METHODS OF MANUFACTURE

The compositions of the present invention can be blended with the aforementioned ingredients by a variety of methods involving intimate admixing of the materials with any additional additives desired in the formulation. Because of the availability of melt blending equipment in commercial polymer processing facilities, melt processing methods are generally preferred. Illustrative examples of equipment used in such melt processing methods include: co-rotating and counter-rotating extruders, single screw extruders, co-kneaders, disc-pack processors and various other types of extrusion equipment. The temperature of the melt in the present process is preferably minimized in order to avoid excessive degradation of the resins. It is often desirable to maintain the melt temperature between about 230° C. and about 350° C. in the molten resin composition, although higher temperatures can be used provided that the residence time of the resin in the processing equipment is kept short. In some aspects the melt processed composition exits processing equipment such as an extruder through small exit holes in a die. The resulting strands of molten resin are cooled by passing the strands through a water bath. The cooled strands can be chopped into small pellets for packaging and further handling.

Compositions can be manufactured by various methods. For example, polymer, and/or other optional components are first blended, optionally with fillers in a HENSCHEL-Mixer® high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a side stuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

In a further aspect, during the injection molding step, the optional phosphorus-containing flame retardant and thermally conductive filler can be mixed with the thermoplastic polymer. In another aspect, the blend composition further comprises one or more optional additives selected from an primary antioxidant, secondary anti-oxidant, additional fillers, and stabilizer. In a still further aspect, single shot injection molding can be used to produce the parts or articles to be laser structured. In another aspect, additional ingredients can be added to the polymer composition after this step.

In one aspect, the invention relates to methods of improving mechanical performance properties of a blended thermoplastic composition, the method comprising the step of combining: (a) from about 20 wt % to about 80 wt % of a first polycarbonate polymer component; (b) from about 1 wt % to about 30 wt % of at least one polycarbonate-polysiloxane copolymer component; (c) from about 1 wt % to about 30 wt % of a second polycarbonate polymer component, wherein the second polycarbonate polymer component is a branched chain polycarbonate polymer; and (d) from greater than 0 wt % to about 50 wt % of a thermally conductive filler component; wherein the combined weight percent value of all components does not exceed about 100 wt %; wherein a molded sample of the blended thermoplastic composition has a through-plane thermal conductivity when determined in accordance with ASTM E1461 of greater than or equal to about 0.4 W/mK; and wherein a molded sample of the blended thermoplastic composition has an in-plane thermal conductivity when determined in accordance with ASTM E1461 of greater than or equal to about 1.0 W/mK.

In a further aspect, the invention relates to the method of preparing a blended thermoplastic composition as described herein above, wherein mixing comprises the steps of (a) dry blending from about 20 wt % to about 80 wt % of the first polycarbonate polymer component with from about 1 wt % to about 30 wt % of at least one polycarbonate-polysiloxane copolymer component and from about 1 wt % to about 30 wt % of a second polycarbonate polymer component, wherein the second polycarbonate polymer component is a branched chain polycarbonate polymer to provide a polycarbonate dry blended mixture; (b) feeding the polycarbonate dry blended mixture into an extruder apparatus; and (c) compounding in the extruder apparatus the polycarbonate dry blended mixture with from greater than about 0% wt % to about 50% wt % of a thermally conductive filler component.

In a further aspect, the invention relates to the method of preparing a blended thermoplastic composition as described herein above, wherein mixing further comprises feeding into the extruder apparatus in a downstream extruder zone from about 25 wt % to about 60 wt % of a reinforcing filler.

In a further aspect, the invention relates to methods of preparing a blended thermoplastic composition, comprising the steps: (a) dry blending the following to form a polycarbonate dry blended mixture: (i) from about 20 wt % to about 80 wt % of a first polycarbonate polymer component; (ii) from about 1 wt % to about 30 wt % of a second polycarbonate polymer component, wherein the second polycarbonate polymer component is a branched chain polycarbonate polymer; and (iii) from about 1 wt % to about 30 wt % of at least one polycarbonate-polysiloxane copolymer component; (b) feeding the polycarbonate dry blended mixture into an extruder apparatus; and (c) feeding into the extruder apparatus in a downstream extruder zone from greater than 0 wt % to about 50 wt % of a thermally conductive filler component; wherein the combined weight percent value of all components does not exceed about 100 wt %; wherein all weight percent values are based on the total weight of the composition; wherein a molded sample of the blended thermoplastic composition has a through-plane thermal conductivity when determined in accordance with ASTM E1461 of greater than or equal to about 0.4 W/mK; and wherein a molded sample of the blended thermoplastic composition has an in-plane thermal conductivity when determined in accordance with ASTM E1461 of greater than or equal to about 1.0 W/mK.

In various aspects, the invention relates to the method of preparing a blended thermoplastic composition as described herein above, the method further comprising feeding into the extruder apparatus in a downstream extruder zone from greater than 0 wt % to about 50 wt % of a reinforcing component. In a further aspect, the reinforcing component is selected from glass beads, glass fiber, glass flakes, mica, talc, clay, wollastonite, zinc sulfide, zinc oxide, carbon fiber, ceramic-coated graphite, and titanium dioxide.

In various aspects, the invention relates to the method of preparing a blended thermoplastic composition as described herein above, the method further comprising feeding into the extruder apparatus in a downstream extruder zone from greater than 0 wt % to about 20 wt % of a flame retardant. In a further aspect, the flame retardant is a phosphorus-containing flame retardant. In a still further aspect, the phosphorus-containing flame retardant is selected from a phosphine, a phosphine oxide, a bisphosphine, a phosphonium salt, a phosphinic acid salt, a phosphoric ester, a phosphorous ester, and an aromatic cyclic phosphazene compound, or combinations thereof. In a yet further aspect, the flame retardant is selected from rescorcinol bis(diphenyl phosphate), resorcinol bis(dixylenyl phosphate), hydroquinone bis(diphenyl phosphate), bisphenol-A bis(diphenyl phosphate), 4,4′-biphenol bis(diphenyl phosphate), triphenyl phosphate, methylneopentyl phosphite, pentaerythritol diethyl diphosphite, methyl neopentyl phosphonate, phenyl neopentyl phosphate, pentaerythritol diphenyldiphosphate, dicyclopentyl hypodiphosphate, dineopentyl hypophosphite, phenylpyrocatechol phosphite, ethylpyrocatechol phosphate, dipyrocatechol hypodiphosphate, and an aromatic cyclic phosphazene compound, or combinations thereof.

In various aspects, the invention relates to the method of preparing a blended thermoplastic composition as described herein above, the method further comprising feeding into the extruder apparatus in a downstream extruder zone from greater than 0 wt % to about 5 wt % of at least one additive. In a further aspect, the additive is selected from an anti-drip agent, antioxidant, antistatic agent, chain extender, colorant, de-molding agent, dye, flow promoter, flow modifier, light stabilizer, lubricant, mold release agent, pigment, quenching agent, thermal stabilizer, UV absorbent substance, UV reflectant substance, and UV stabilizer, or combinations thereof.

### M. ARTICLES OF MANUFACTURE

In one aspect, the present invention pertains to shaped, formed, or molded articles comprising the blended thermoplastic compositions. The blended thermoplastic compositions can be molded into useful shaped articles by a variety of means such as injection molding, extrusion, rotational molding, blow molding and thermoforming to form articles such as, for example, cellular devices, smart phones, Wi-Fi devices, personal computers, notebook and portable computers, cell phone antennas and other such communications equipment, medical applications, RFID applications, automotive applications, and the like. In a further aspect, the article is molded. In a still further aspect, the article is extrusion molded. In yet a further aspect, the article is injection molded.

In various aspects, the polymer composition can be used in the field of electronics. In a further aspect, non-limiting examples of fields which can use the disclosed blended thermoplastic polymer compositions include electrical, electro-mechanical, radio frequency (RF) technology, telecommunication, automotive, aviation, medical, sensor, military, and security. In a still further aspect, the use of the disclosed blended thermoplastic polymer compositions can also be present in overlapping fields, for example in mechatronic systems that integrate mechanical and electrical properties which may, for example, be used in automotive or medical engineering.

In a further aspect, the article is selected from a computer device, electromagnetic interference device, printed circuit, Wi-Fi device, Bluetooth device, GPS device, cellular antenna device, smart phone device, automotive device, medical device, sensor device, security device, shielding device, RF antenna device, LED device, and RFID device. In a still further aspect, the article is selected from a computer device, electromagnetic interference device, automotive device, medical device, sensor device, security device, shielding device, RF antenna device, LED device and RFID device. In yet a further aspect, the article is selected from a computer device, sensor device, security device, RF antenna device, LED device and RFID device. In a still further aspect, the article is selected from a computer device, LED device and RFID device. In yet a further aspect, the article is a LED device. In an even further aspect, the LED device is a LED lamp.

In a further aspect, the article is selected from a RF antenna device, cellular antenna device, smart phone device, and electromagnetic interference device. In a still further aspect, the article is an external cover or frame for a RF antenna device, cellular antenna device, smart phone device, or electromagnetic interference device. In yet a further aspect, the article is a central frame for a RF antenna device, cellular antenna device, smart phone device, or electromagnetic interference device. In an even further aspect, the article is a RF antenna device cover. In a still further aspect, the article is a RF antenna device external frame. In yet a further aspect, the article is a RF antenna device central frame.

In a further aspect, the article is a cellular antenna device cover. In a still further aspect, the article is a cellular antenna device external frame. In yet a further aspect, the article is a cellular antenna device central frame.

In a further aspect, the article is a smart phone device cover. In a still further aspect, the article is a smart phone device external frame. In yet a further aspect, the article is a smart phone device central frame.

In various aspects, molded articles according to the present invention can be used to produce a device in one or more of the foregoing fields. In a still further aspect, non-limiting examples of such devices in these fields which can use the disclosed blended thermoplastic polymer compositions according to the present invention include computer devices, household appliances, decoration devices, electromagnetic interference devices, printed circuits, Wi-Fi devices, Bluetooth devices, GPS devices, cellular antenna devices, smart phone devices, automotive devices, military devices, aerospace devices, medical devices, such as hearing aids, sensor devices, security devices, shielding devices, RF antenna devices, or RFID devices.

In a further aspect, the molded articles can be used to manufacture devices in the automotive field. In a still further aspect, non-limiting examples of such devices in the automotive field which can use the disclosed blended thermoplastic compositions in the vehicle's interior include adaptive cruise control, headlight sensors, windshield wiper sensors, and door/window switches. In a further aspect, non-limiting examples of devices in the automotive field which can the disclosed blended thermoplastic compositions in the vehicle's exterior include pressure and flow sensors for engine management, air conditioning, crash detection, and exterior lighting fixtures.

In a further aspect, the resulting disclosed compositions can be used to provide any desired shaped, formed, or molded articles. For example, the disclosed compositions can be molded into useful shaped articles by a variety of means such as injection molding, extrusion, rotational molding, blow molding and thermoforming. As noted above, the disclosed compositions are particularly well suited for use in the manufacture of electronic components and devices. As such, according to some aspects, the disclosed compositions can be used to form articles such as printed circuit board carriers, burn in test sockets, flex brackets for hard disk drives, and the like.

In various aspects, the present invention pertains to and includes at least the following aspects.

Aspect 1. A blended thermoplastic composition comprising: (a) from about 20 wt % to about 80 wt % of a first polycarbonate polymer component; (b) from about 1 wt % to about 30 wt % of a second polycarbonate polymer component, wherein the second polycarbonate polymer component is a branched chain polycarbonate polymer; (c) from about 1 wt % to about 30 wt % of at least one polycarbonate-polysiloxane copolymer component; and (d) from greater than 0 wt % to about 50 wt % of a thermally conductive filler component; wherein the combined weight percent value of all components does not exceed about 100 wt %; wherein all weight percent values are based on the total weight of the composition; wherein a molded sample of the blended thermoplastic composition has a through-plane thermal conductivity when determined in accordance with ASTM E1461 of greater than or equal to about 0.4 W/mK; and wherein a molded sample of the blended thermoplastic composition has an in-plane thermal conductivity when determined in accordance with ASTM E1461 of greater than or equal to about 1.0 W/mK.

Aspect 2. The composition of Aspect 1, wherein the first polycarbonate polymer component is a homopolymer.

Aspect 3. The composition of Aspect 2, wherein the homopolymer comprises repeating units derived from bisphenol A.

Aspect 4. The composition of Aspect 1, wherein the first polycarbonate polymer component is a copolymer.

Aspect 5. The composition of Aspect 4, wherein the copolymer comprises repeating units derived from BPA.

Aspect 6. The composition of Aspect 4, wherein the copolymer comprises repeating units derived from sebacic acid.

Aspect 7. The composition of Aspect 4, wherein the copolymer comprises repeating units derived from sebacic acid and BPA.

Aspect 8. The composition of any of Aspect 1-Aspect 7, wherein the first polycarbonate polymer component has a weight average molecular weight from about 15,000 to about 75,000 grams/mole, as measured by gel permeation chromatography using BPA polycarbonate standards.

Aspect 9. The composition of any of Aspect 1-Aspect 8, wherein the first polycarbonate polymer component is blend comprising at least two polycarbonate polymers.

Aspect 10. The composition of any of Aspect 1-Aspect 9, wherein the first polycarbonate polymer component is present in an amount from about 35 wt % to about 70 wt %.

Aspect 11. The composition of any of Aspect 1-Aspect 9, wherein the first polycarbonate polymer component is present in an amount from about 35 wt % to about 60 wt %.

Aspect 12. The composition of any of Aspect 1-Aspect 9, wherein the first polycarbonate polymer component is present in an amount from about 45 wt % to about 70 wt %.

Aspect 13. The composition of any of Aspect 1-Aspect 9, wherein the first polycarbonate polymer component is present in an amount from about 45 wt % to about 60 wt %.

Aspect 14. The composition of any of Aspect 1-Aspect 9, wherein the first polycarbonate polymer component is present in an amount from about 60 wt % to about 70 wt %.

Aspect 15. The composition of any of Aspect 1-Aspect 14, wherein the second polycarbonate polymer component comprises residues derived from tris-(hydroxyphenyl)ethane.

Aspect 16. The composition of any of Aspect 1-Aspect 15, wherein the second polycarbonate polymer component is end-capped.

Aspect 17. The composition of any of Aspect 1-Aspect 15, wherein the second polycarbonate polymer component is end-capped with p-hydroxybenzonitrile.

Aspect 18. The composition of any of Aspect 1-Aspect 17, wherein the second polycarbonate polymer component comprises residues derived from BPA.

Aspect 19. The composition of any of Aspect 1-Aspect 18, wherein the second polycarbonate polymer component is present in an amount from about 5 wt % to about 25 wt %.

Aspect 20. The composition of any of Aspect 1-Aspect 18, wherein the second polycarbonate polymer component is present in an amount from about 5 wt % to about 30 wt %.

Aspect 21. The composition of any of Aspect 1-Aspect 18, wherein the second polycarbonate polymer component is present in an amount from about 10 wt % to about 15 wt %.

Aspect 22. The composition of any of Aspect 1-Aspect 18, wherein the second polycarbonate polymer component is present in an amount from about 10 wt % to about 20 wt %.

Aspect 23. The composition of any of Aspect 1-Aspect 18, wherein the second polycarbonate polymer component is present in an amount from about 15 wt % to about 20 wt %.

Aspect 24. The composition of any of Aspect 1-Aspect 23, wherein the polycarbonate-polysiloxane copolymer component is a polycarbonate-polysiloxane block copolymer.

Aspect 25. The composition of Aspect 24, wherein the polycarbonate block comprises residues derived from BPA.

Aspect 26. The composition of Aspect 24, wherein the polycarbonate block comprising residues derived from BPA is a homopolymer.

Aspect 27. The composition of any of Aspect 1-Aspect 26, wherein the polycarbonate-polysiloxane copolymer component comprises dimethylsiloxane repeating units.

Aspect 28. The composition of any of Aspect 1-Aspect 27, wherein the polycarbonate-polysiloxane copolymer component comprises a polysiloxane block from about 5 wt % to about 30 wt % of the polycarbonate-polysiloxane copolymer component.

Aspect 29. The composition of any of Aspect 1-Aspect 27, wherein the polycarbonate-polysiloxane copolymer component comprises a polysiloxane block less than about 25 wt % of the polycarbonate-polysiloxane copolymer component.

Aspect 30. The composition of any of Aspect 1-Aspect 27, wherein the polycarbonate-polysiloxane copolymer component comprises a polysiloxane block from about 15 wt % to about 25 wt % of the polycarbonate-polysiloxane copolymer component.

Aspect 31. The composition of any of Aspect 1-Aspect 30, wherein the polycarbonate-polysiloxane copolymer component is present in an amount from about 5 wt % to about 20 wt %.

Aspect 32. The composition of any of Aspect 1-Aspect 30, wherein the polycarbonate-polysiloxane copolymer component is present in an amount from about 5 wt % to about 25 wt %.

Aspect 33. The composition of any of Aspect 1-Aspect 30, wherein the polycarbonate-polysiloxane copolymer component is present in an amount from about 10 wt % to about 15 wt %.

Aspect 34. The composition of any of Aspect 1-Aspect 30, wherein the polycarbonate-polysiloxane copolymer component is present in an amount from about 10 wt % to about 20 wt %.

Aspect 35. The composition of any of Aspect 1-Aspect 30, wherein the polycarbonate-polysiloxane copolymer component is present in an amount from about 15 wt % to about 20 wt %.

Aspect 36. The composition of any of Aspect 1-Aspect 30, wherein the polycarbonate-polysiloxane copolymer component is present in an amount greater than 0 wt % to about 20 wt %.

Aspect 37. The composition of any of Aspect 1-Aspect 36, wherein the polycarbonate-polysiloxane copolymer component comprises a blend of polycarbonate-polysiloxane copolymers.

Aspect 38. The composition of any of Aspect 1-Aspect 37, further comprising a polyester polymer component.

Aspect 39. The composition of Aspect 38, wherein the polyester polymer is polybutylene terephthalate.

Aspect 40. The composition of Aspect 38, wherein the polyester polymer is polyethylene terephthalate.

Aspect 41. The composition of any of Aspect 38-Aspect 40, wherein the polyester polymer component is present in an amount from greater than 0 wt % to about 20 wt %.

Aspect 42. The composition of any of Aspect 38-Aspect 40, wherein the polyester polymer component is present in an amount from greater than 0 wt % to about 10 wt %.

Aspect 43. The composition of any of Aspect 38-Aspect 40, wherein the polyester polymer component is present in an amount from greater than about 1 wt % to about 10 wt %.

Aspect 44. The composition of any of Aspect 38-Aspect 40, wherein the polyester polymer component is present in an amount from about 5 wt % to about 15 wt %.

Aspect 45. The composition of any of Aspect 1-Aspect 44, further comprising an impact modifier polymer component.

Aspect 46. The composition of Aspect 45, wherein the impact modifier component comprises at least one acrylonitrile-butadiene-styrene (ABS) polymer, at least one bulk polymerized ABS (BABS) polymer, or at least one methyl methacrylate-butadiene-styrene (MBS) polymer.

Aspect 47. The composition of Aspect 46, wherein the impact modifier component comprises a methacrylate-butadiene-styrene (MBS) polymer.

Aspect 48. The composition of Aspect 46, wherein the impact modifier component comprises an acrylonitrile-butadiene-styrene (ABS) polymer composition.

Aspect 49. The composition of Aspect 48, wherein the ABS polymer composition is an emulsion polymerized ABS.

Aspect 50. The composition of Aspect 48, wherein the ABS polymer composition is a bulk-polymerized ABS.

Aspect 51. The composition of Aspect 48, wherein the ABS polymer composition is a SAN-grafted emulsion ABS.

Aspect 52. The composition of any of Aspect 45-Aspect 51, wherein the impact modifier is present is an amount greater than 0 wt % to about 20 wt %.

Aspect 53. The composition of any of Aspect 45-Aspect 51, wherein the impact modifier is present is an amount greater than 0 wt % to about 10 wt %.

Aspect 54. The composition of any of Aspect 45-Aspect 51, wherein the impact modifier is present is an amount from about 1 wt % to about 10 wt %.

Aspect 55. The composition of any of Aspect 45-Aspect 51, wherein the impact modifier is present is an amount from about 5 wt % to about 15 wt %.

Aspect 56. The composition of any of Aspect 1-Aspect 55, wherein the thermally conductive filler is selected from AlN, Al₄C₃, Al₂O₃, BN, AlON, MgSiN₂, SiC, Si₃N₄, graphite, expanded graphite, graphene, carbon fiber, ZnS, CaO, MgO, ZnO, TiO₂, H₂Mg₃(SiO₃)₄, CaCO₃, Mg(OH)₂, mica, BaO, γ-AlO(OH), α-AlO(OH), Al(OH)₃, BaSO₄, CaSiO₃, ZrO₂, SiO₂, a glass bead, a glass fiber, MgO.xAl₂O₃, CaMg(CO₃)₂, and a clay, or a combinations thereof.

Aspect 57. The composition of any of Aspect 1-Aspect 55, wherein the thermally conductive filler component comprises at least one high thermally conductive filler.

Aspect 58. The composition of Aspect 57, wherein the high thermally conductive filler has a conductivity greater than or equal to about 30 W/mK when determined in accordance with ASTM E1225.

Aspect 59. The composition of Aspect 57 or Aspect 58, wherein the high thermally conductive filler is selected from AlN, Al₄C₃, Al₂O₃, BN, AlON, MgSiN₂, SiC, Si₃N₄, graphite, expanded graphite, graphene, and carbon fiber, or a combinations thereof.

Aspect 60. The composition of Aspect 57 or Aspect 58, wherein the high thermally conductive filler is selected from AlN, Al₂O₃, BN, SiC, graphite, expanded graphite, and carbon fiber, or combinations thereof.

Aspect 61. The composition of Aspect 57 or Aspect 58, wherein the high thermally conductive filler is selected from BN, graphite, and expanded graphite, or combinations thereof.

Aspect 62. The composition of any of Aspect 1-Aspect 61, wherein the thermally conductive filler component comprises at least one intermediate thermally conductive filler.

Aspect 63. The composition of Aspect 62, wherein the intermediate thermally conductive filler component has a conductivity from about 10 W/mK to about 30 W/mK when determined in accordance with ASTM E1225.

Aspect 64. The composition of Aspect 62 or Aspect 63, wherein the intermediate thermally conductive filler is selected from ZnS, CaO, MgO, ZnO, and TiO₂, or combinations thereof.

Aspect 65. The composition of Aspect 62 or Aspect 63, wherein the intermediate thermally conductive filler is TiO₂.

Aspect 66. The composition of any of Aspect 1-Aspect 61, wherein the thermally conductive filler component comprises at least one low thermally conductive filler.

Aspect 67. The composition of Aspect 66, wherein the low thermally conductive filler component has a conductivity less than about 10 W/mK when determined in accordance with ASTM E1225.

Aspect 68. The composition of Aspect 66 or Aspect 67, wherein the low thermally conductive filler is selected from H₂Mg₃(SiO₃)₄, CaCO₃, Mg(OH)₂, mica, BaO, γ-AlO(OH), α-AlO(OH), Al(OH)₃, BaSO₄, CaSiO₃, ZrO₂, SiO₂, a glass bead, a glass fiber, MgO.xAl2O3, CaMg(CO₃)₂, a clay, or a combination thereof.

Aspect 69. The composition of Aspect 66 or Aspect 67, wherein the low thermally conductive filler is selected from H₂Mg₃(SiO₃)₄, Mg(OH)₂, γ-AlO(OH), α-AlO(OH), and Al(OH)₃, or combinations thereof.

Aspect 70. The composition of Aspect 66 or Aspect 67, wherein the low thermally conductive filler is selected from H₂Mg₃(SiO₃)₄, γ-AlO(OH), α-AlO(OH), and Al(OH)₃, or combinations thereof.

Aspect 71. The composition of Aspect 66 or Aspect 67, wherein the low thermally conductive filler is H₂Mg₃(SiO₃)₄.

Aspect 72. The composition of any of Aspect 1-Aspect 71, wherein the thermally conductive filler component is present in an amount from about 1 wt % to about 50% wt %.

Aspect 73. The composition of any of Aspect 1-Aspect 71, wherein the thermally conductive filler component is present in an amount from about 10 wt % to about 50% wt %.

Aspect 74. The composition of any of Aspect 1-Aspect 71, wherein the thermally conductive filler component is present in an amount from about 20 wt % to about 40% wt %.

Aspect 75. The composition of any of Aspects 1-55, wherein the thermally conductive filler component comprises at least one intermediate thermally conductive filler and at least one low thermally conductive filler; wherein the intermediate thermally conductive filler component has a conductivity from about 10 W/mK to about 30 W/mK when determined in accordance with ASTM E1225; wherein the intermediate thermally conductive filler component is present in an amount from greater than 0 wt % to about 30 wt %; wherein the low thermally conductive filler component has a conductivity less than about 10 W/mK when determined in accordance with ASTM E1225; and wherein the low thermally conductive filler component is present in an amount from greater than 0 wt % to about 30 wt %.

Aspect 76. The composition of any of Aspects 1-55, wherein the thermally conductive filler component comprises TiO₂ and H₂Mg₃(SiO₃)₄.

Aspect 77. The compositions of Aspect 75 or Aspect 76, wherein the thermally conductive filler component comprising at least one intermediate thermally conductive filler present in an amount from about 15 wt % to about 35% wt %. and at least one low thermally conductive filler is present in an amount from about 5 wt % to about 20% wt %.

Aspect 78. The compositions of Aspect 75 or Aspect 76, wherein the thermally conductive filler component comprising at least one intermediate thermally conductive filler present in an amount from about 15 wt % to about 25% wt %. and at least one low thermally conductive filler is present in an amount from about 10 wt % to about 20% wt %.

Aspect 79. The composition of any of Aspect 1-Aspect 78, further comprising a reinforcing component.

Aspect 80. The composition of Aspect 79, wherein the reinforcing component is selected from glass beads, glass fiber, glass flakes, mica, talc, clay, wollastonite, zinc sulfide, zinc oxide, carbon fiber, ceramic-coated graphite, and titanium dioxide.

Aspect 81. The composition of Aspect 80, wherein the reinforcing component is a glass fiber.

Aspect 82. The composition of Aspect 81, wherein the glass fiber is continuous.

Aspect 83. The composition of Aspect 81, wherein the glass fiber is chopped.

Aspect 84. The composition of Aspect 81, wherein the glass fiber has a round, flat, or irregular cross-section.

Aspect 85. The composition of Aspect 84, wherein the glass fiber has a round cross-section.

Aspect 86. The composition of Aspect 85, wherein the glass fiber has a diameter from about 4 μm to about 15 μm.

Aspect 87. The composition of any of Aspect 79-Aspect 86, wherein the reinforcing component is particulate.

Aspect 88. The composition of any of Aspect 79-Aspect 86, wherein the reinforcing component is fibrous.

Aspect 89. The composition of Aspect 88, wherein the fibrous filler has a circular cross-section.

Aspect 90. The composition of Aspect 88, wherein the fibrous filler has a non-circular cross-section.

Aspect 91. The composition of any of Aspect 79-Aspect 90, wherein the reinforcing component is present in an amount from greater than 0 wt % to about 50 wt %.

Aspect 92. The composition of any of Aspect 79-Aspect 90, wherein the reinforcing component is present in an amount from greater than 0 wt % to about 40 wt %.

Aspect 93. The composition of any of Aspect 79-Aspect 90, wherein the reinforcing component is present in an amount from greater than 0 wt % to about 30 wt %.

Aspect 94. The composition of any of Aspect 79-Aspect 90, wherein the reinforcing component is present in an amount from greater than 0 wt % to about 25 wt %.

Aspect 95. The composition of any of Aspect 79-Aspect 90, wherein the reinforcing component is present in an amount from greater than 0 wt % to about 20 wt %.

Aspect 96. The composition of any of Aspect 79-Aspect 90, wherein the reinforcing component is present in an amount from greater than 0 wt % to about 15 wt %.

Aspect 97. The composition of any of Aspect 1-Aspect 96, further comprising at least one flame retardant.

Aspect 98. The composition of Aspect 97, wherein the flame retardant is a phosphorus-containing flame retardant.

Aspect 99. The composition of Aspect 98, wherein the phosphorus-containing flame retardant is selected from a phosphine, a phosphine oxide, a bisphosphine, a phosphonium salt, a phosphinic acid salt, a phosphoric ester, and a phosphorous ester.

Aspect 100. The composition of any of Aspect 98 or Aspect 99, wherein the phosphorus-containing flame retardant is an aromatic cyclic phosphazene compound.

Aspect 101. The composition of Aspect 100, wherein the aromatic cyclic phosphazene compound has a structure represented by the formula:

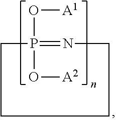

wherein each of A1 and A2 is independently an aryl group having 6 to 10 carbon atoms optionally substituted with 1 to 4 alkyl groups having 1 to 4 carbon atoms; and wherein n is an integer of 3 to 6.

Aspect 102. The composition of Aspect 101, wherein aromatic cyclic phosphazene has a structure represented by the formula:

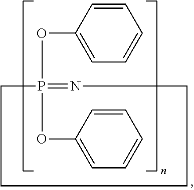

wherein n is 3 to 6.

Aspect 103. The composition of any of Aspect 98 or Aspect 99, wherein the phosphorus-containing flame retardant is selected from rescorcinol bis(diphenyl phosphate), resorcinol bis(dixylenyl phosphate), hydroquinone bis(diphenyl phosphate), bisphenol-A bis(diphenyl phosphate), 4,4′-biphenol bis(diphenyl phosphate), triphenyl phosphate, methylneopentyl phosphite, pentaerythritol diethyl diphosphite, methyl neopentyl phosphonate, phenyl neopentyl phosphate, pentaerythritol diphenyldiphosphate, dicyclopentyl hypodiphosphate, dineopentyl hypophosphite, phenylpyrocatechol phosphite, ethylpyrocatechol phosphate and dipyrocatechol hypodiphosphate.

Aspect 104. The composition of any of Aspect 98 or Aspect 99, wherein the phosphorus-containing flame retardant comprises selected from resorcinol bis(biphenyl phosphate), bisphenol A bis(diphenyl phosphate), or hydroquinone bis(diphenyl phosphate), or mixtures thereof.

Aspect 105. The composition of any of Aspect 98 or Aspect 99, wherein the phosphorus-containing flame retardant comprises bisphenol A bis(diphenyl phosphate).

Aspect 106. The composition of any of aspects Aspect 98 or Aspect 99, wherein the phosphorus-containing flame retardant comprises resorcinol bis(biphenyl phosphate).

Aspect 107. The composition of any of Aspect 97-Aspect 106, wherein the flame retardant is present in an amount less than or equal to about 20 wt %.

Aspect 108. The composition of any of Aspect 98 or Aspect 99, wherein the flame retardant comprises a first flame retardant and a second flame retardant.

Aspect 109. The composition of Aspect 108, wherein the first flame retardant selected from selected from rescorcinol bis(diphenyl phosphate), resorcinol bis(dixylenyl phosphate), hydroquinone bis(diphenyl phosphate), bisphenol-A bis(diphenyl phosphate), 4,4′-biphenol bis(diphenyl phosphate), triphenyl phosphate, methylneopentyl phosphite, pentaerythritol diethyl diphosphite, methyl neopentyl phosphonate, phenyl neopentyl phosphate, pentaerythritol diphenyldiphosphate, dicyclopentyl hypodiphosphate, dineopentyl hypophosphite, phenylpyrocatechol phosphite, ethylpyrocatechol phosphate and dipyrocatechol hypodiphosphate; and wherein the second flame retardant is an aromatic cyclic phosphazene compound has a structure represented by the formula:

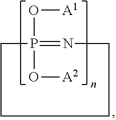

wherein each of A1 and A2 is independently an aryl group having 6 to 10 carbon atoms optionally substituted with 1 to 4 alkyl groups having 1 to 4 carbon atoms; and wherein n is an integer of 3 to 6.

Aspect 110. The composition of Aspect 109, wherein the first flame retardant selected from selected from rescorcinol bis(diphenyl phosphate), resorcinol bis(dixylenyl phosphate), bisphenol-A bis(diphenyl phosphate), and 4,4′-biphenol bis(diphenyl phosphate); and wherein the second flame retardant is an aromatic cyclic phosphazene compound has a structure represented by the formula:

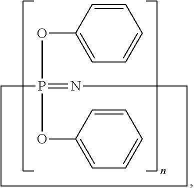

wherein n is 3 to 6.

Aspect 111. The composition of any of Aspect 108-Aspect 110, wherein the wt % of the first flame retardant and second flame retardant together is less than or equal to about 20 wt %.

Aspect 112. The composition of any of Aspect 1-Aspect 111, further comprising at least one additive.

Aspect 113. The composition of Aspect 112, wherein the additive is selected from an anti-drip agent, antioxidant, antistatic agent, chain extender, colorant, de-molding agent, dye, flow promoter, flow modifier, light stabilizer, lubricant, mold release agent, pigment, quenching agent, thermal stabilizer, UV absorbent substance, UV reflectant substance, and UV stabilizer, or combinations thereof.

Aspect 114. The composition of Aspect 113, wherein the anti-drip agent is present in an amount from about 0.05 wt % to about 3 wt %.

Aspect 115. The composition of Aspect 113, wherein the anti-drip agent is present in an amount from about 0.1 wt % to about 2 wt %.

Aspect 116. The composition of Aspect 113, wherein the anti-drip agent is present in an amount from about 0.1 wt % to about 1 wt %.

Aspect 117. The composition of any of Aspect 113-Aspect 116, wherein the anti-drip agent is a styrene-acrylonitrile copolymer encapsulated polytetrafluoroethylene.

Aspect 118. The composition of Aspect 113, wherein the antioxidant is a primary antioxidant, a secondary antioxidant, or combinations thereof.

Aspect 119. The composition of Aspect 118, wherein the primary antioxidant is selected from a hindered phenol and secondary aryl amine, or a combination thereof.

Aspect 120. The composition of Aspect 119, wherein the hindered phenol comprises one or more compounds selected from triethylene glycol bis[3-(3-t-butyl-5-methyl-4-hydroxyphenyl)propionate], 1,6-hexanediol bis[3-(3,5-di-t-butyl-4-hydroxyphenyl)propionate], 2,4-bis(n-octylthio)-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl 3-(3,5-di-t-butyl-4-hydroxyphenyl)propionate, N,N′-hexamethylene bis(3,5-di-t-butyl-4-hydroxy-hydrocinnamamide), tetrakis(methylene 3,5-di-tert-butyl-hydroxycinnamate)methane, and octadecyl 3,5-di-tert-butylhydroxyhydrocinnamate.

Aspect 121. The composition of Aspect 119 or Aspect 120, wherein the hindered phenol comprises octadecyl-3-(3,5-di-t-butyl-4-hydroxyphenyl)-propionate.

Aspect 122. The composition of Aspect 119 or Aspect 120, wherein the primary anti-oxidant is present in an amount from about 0.01 wt % to about 0.50 wt %.

Aspect 123. The composition of Aspect 119 or Aspect 120, wherein the primary anti-oxidant is present in an amount from about 0.01 wt % to about 0.20 wt %.

Aspect 124. The composition of Aspect 119 or Aspect 120, wherein the primary anti-oxidant is present in an amount from about 0.01 wt % to about 0.10 wt %.

Aspect 125. The composition of Aspect 118, wherein the secondary anti-oxidant is selected from an organophosphate and thioester, or a combination thereof.

Aspect 126. The composition of Aspect 125 or Aspect 126, wherein the secondary anti-oxidant comprises one or more compounds selected from tetrakis(2,4-di-tert-butylphenyl) [1,1-biphenyl]-4,4′-diylbisphosphonite, tris(2,4-di-tert-butylphenyl) phosphite, bis(2,4-di-tert-butylphenyl)pentaerythritol diphosphite, bis(2,4-dicumylphenyl)pentaerytritoldiphosphite, tris(nonyl phenyl)phosphite, and distearyl pentaerythritol diphosphite.

Aspect 127. The composition of Aspect 125 or Aspect 126, wherein the secondary anti-oxidant comprises tris(2,4-di-tert-butylphenyl) phosphite.

Aspect 128. The composition of Aspect 125-Aspect 127, wherein the secondary anti-oxidant is present in an amount from about 0.01 wt % to about 0.50 wt %.

Aspect 129. The composition of Aspect 125-Aspect 127, wherein the secondary anti-oxidant is present in an amount from about 0.01 wt % to about 0.20 wt %.

Aspect 130. The composition of Aspect 125-Aspect 127, wherein the secondary anti-oxidant is present in an amount from about 0.01 wt % to about 0.10 wt %.

Aspect 131. An article comprising any of the compositions of Aspect 1-Aspect 130.

Aspect 132. The article of Aspect 131, wherein the article is molded.

Aspect 133. The article of Aspect 132, wherein the article is extrusion molded.

Aspect 134. The article of Aspect 132, wherein the article is injection molded.

Aspect 135. The article of any of Aspect 131-Aspect 134, wherein the article is selected from a computer device, electromagnetic interference device, printed circuit, Wi-Fi device, Bluetooth device, GPS device, cellular antenna device, smart phone device, automotive device, medical device, sensor device, security device, shielding device, RF antenna device, LED device and RFID device.

Aspect 136. The article of any of Aspect 131-Aspect 134, wherein the article is selected from a computer device, electromagnetic interference device, automotive device, medical device, sensor device, security device, shielding device, RF antenna device, LED device and RFID device.

Aspect 137. The article of any of Aspect 131-Aspect 134, wherein the article is selected from a computer device, sensor device, security device, RF antenna device, LED device and RFID device.

Aspect 138. The article of any of Aspect 131-Aspect 134, wherein the article is selected from a computer device, LED device and RFID device.

Aspect 139. The article of any of Aspect 131-Aspect 134, wherein the article is a LED device.

Aspect 140. The article of Aspects 135-139, wherein the LED device is a LED lamp.

Aspect 141. The article of any of Aspect 131-Aspect 134, wherein the article is selected from a RF antenna device, cellular antenna device, smart phone device, and electromagnetic interference device.

Aspect 142. The article of Aspect 141, wherein the article is an external cover or frame for a RF antenna device, cellular antenna device, smart phone device, or electromagnetic interference device.

Aspect 143. The article of Aspect 141, wherein the article is a central frame for a RF antenna device, cellular antenna device, smart phone device, or electromagnetic interference device.

Aspect 144. The article of Aspects 141-143, wherein the article is a RF antenna device cover.

Aspect 145. The article of Aspects 141-143, wherein the article is a RF antenna device external frame.

Aspect 146. The article of Aspects 141-143, wherein the article is a RF antenna device central frame.

Aspect 147. The article of Aspects 141-143, wherein the article is a cellular antenna device cover.

Aspect 148. The article of Aspects 141-143, wherein the article is a cellular antenna device external frame.

Aspect 149. The article of Aspects 141-143, wherein the article is a cellular antenna device central frame.

Aspect 150. The article of Aspects 141-143, wherein the article is a smart phone device cover.

Aspect 151. The article of Aspects 141-143, wherein the article is a smart phone device external frame.

Aspect 152. The article of Aspects 141-143, wherein the article is a smart phone device central frame.

Aspect 153. A method of preparing a blended thermoplastic composition, comprising mixing: (a) from about 20 wt % to about 80 wt % of a first polycarbonate polymer component; (b) from about 1 wt % to about 30 wt % of a second polycarbonate polymer component, wherein the second polycarbonate polymer component is a branched chain polycarbonate polymer; (c) from about 1 wt % to about 30 wt % of at least one polycarbonate-polysiloxane copolymer component; and (d) from greater than 0 wt % to about 50 wt % of a thermally conductive filler component; wherein the combined weight percent value of all components does not exceed about 100 wt %; wherein all weight percent values are based on the total weight of the composition; wherein a molded sample of the blended thermoplastic composition has a through-plane thermal conductivity when determined in accordance with ASTM E1461 of greater than or equal to about 0.4 W/mK; and wherein a molded sample of the blended thermoplastic composition has an in-plane thermal conductivity when determined in accordance with ASTM E1461 of greater than or equal to about 1.0 W/mK.

Aspect 154. The method of Aspect 153, wherein mixing comprises the steps of: (a) dry blending the following to form a polycarbonate dry blended mixture: (i) from 20 wt % to about 80 wt % of a first polycarbonate polymer component; (ii) from about 1 wt % to about 30 wt % of a second polycarbonate polymer component, wherein the second polycarbonate polymer component is a branched chain polycarbonate polymer; and (iii) from about 1 wt % to about 30 wt % of at least one polycarbonate-polysiloxane copolymer component; (b) feeding the polycarbonate dry blended mixture into an extruder apparatus; and (c) compounding in the extruder apparatus the polycarbonate dry blended mixture with from greater than 0 wt % to about 50 wt % of a thermally conductive filler component.

Aspect 155. The method of Aspect 154, further comprising feeding into the extruder apparatus in a downstream extruder zone from about 25 wt % to about 60 wt % of a reinforcing filler.

Aspect 156. A method of preparing a blended thermoplastic composition, comprising the steps: (a) dry blending the following to form a polycarbonate dry blended mixture: (i) from about 20 wt % to about 80 wt % of a first polycarbonate polymer component; (ii) from about 1 wt % to about 30 wt % of a second polycarbonate polymer component, wherein the second polycarbonate polymer component is a branched chain polycarbonate polymer; and (iii) from about 1 wt % to about 30 wt % of at least one polycarbonate-polysiloxane copolymer component; (b) feeding the polycarbonate dry blended mixture into an extruder apparatus; and (c) feeding into the extruder apparatus in a downstream extruder zone from greater than 0 wt % to about 50 wt % of a thermally conductive filler component; wherein the combined weight percent value of all components does not exceed about 100 wt %; wherein all weight percent values are based on the total weight of the composition; wherein a molded sample of the blended thermoplastic composition has a through-plane thermal conductivity when determined in accordance with ASTM E1461 of greater than or equal to about 0.4 W/mK; and wherein a molded sample of the blended thermoplastic composition has an in-plane thermal conductivity when determined in accordance with ASTM E1461 of greater than or equal to about 1.0 W/mK.

Aspect 157. The method of Aspect 156, further comprising feeding into the extruder apparatus in a downstream extruder zone from greater than 0 wt % to about 50 wt % of a reinforcing component.

Aspect 158. The method of Aspect 157, wherein the reinforcing component is selected from glass beads, glass fiber, glass flakes, mica, talc, clay, wollastonite, zinc sulfide, zinc oxide, carbon fiber, ceramic-coated graphite, and titanium dioxide.

Aspect 159. The method of any Aspect 156-Aspect 158, further comprising feeding into the extruder apparatus in a downstream extruder zone from greater than 0 wt % to about 20 wt % of a flame retardant.

Aspect 160. The method of Aspect 159, wherein the flame retardant is a phosphorus-containing flame retardant.

Aspect 161. The method of Aspect 159 or Aspect 160, wherein the flame retardant is selected from a phosphine, a phosphine oxide, a bisphosphine, a phosphonium salt, a phosphinic acid salt, a phosphoric ester, and a phosphorous ester.

Aspect 162. The method of Aspect 159 or Aspect 160, wherein the flame retardant is selected from rescorcinol bis(diphenyl phosphate), resorcinol bis(dixylenyl phosphate), hydroquinone bis(diphenyl phosphate), bisphenol-A bis(diphenyl phosphate), 4,4′-biphenol bis(diphenyl phosphate), triphenyl phosphate, methylneopentyl phosphite, pentaerythritol diethyl diphosphite, methyl neopentyl phosphonate, phenyl neopentyl phosphate, pentaerythritol diphenyldiphosphate, dicyclopentyl hypodiphosphate, dineopentyl hypophosphite, phenylpyrocatechol phosphite, ethylpyrocatechol phosphate, dipyrocatechol hypodiphosphate, and an aromatic cyclic phosphazene compound, or combinations thereof.

Aspect 163. The method of any of Aspect 156-Aspect 162, further comprising feeding into the extruder apparatus in a downstream extruder zone from greater than 0 wt % to about 5 wt % of at least one additive.

Aspect 164. The method of Aspect 163, wherein the additive is selected from an anti-drip agent, antioxidant, antistatic agent, chain extender, colorant, de-molding agent, dye, flow promoter, flow modifier, light stabilizer, lubricant, mold release agent, pigment, quenching agent, thermal stabilizer, UV absorbent substance, UV reflectant substance, and UV stabilizer, or combinations thereof.

Without further elaboration, it is believed that one skilled in the art can, using the description herein, utilize the present invention. The following examples are included to provide addition guidance to those skilled in the art of practicing the claimed invention. The examples provided are merely representative of the work and contribute to the teaching of the present invention. Accordingly, these examples are not intended to limit the invention in any manner.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

### N. EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

The materials shown in Table 1 were used to prepare the compositions described and evaluated herein. All samples were prepared by melt extrusion on a Toshiba Twin screw extruder, using different melt temperature and RPM according to different base resin. Tests were all conducted in accordance with ASTM standards, referenced in each test below.

Izod Impact strength was determined at 23° C. in accordance with ASTM D256 (Notched Izod impact strength, “NII”), and in accordance with ASTM D4812 (Unnotched Izod impact strength, “UII”).

Tensile testing was carried out at 5 mm/min in accordance with ASTM D638.

Flexural testing was carried out at 1.27 mm/min in accordance with ASTM D790.

Density was determined using a water immersion method in accordance with ASTM D792.

Thermal conductivity (“TC”) was conducted in accordance with ASTM E1461 measured using a Nanoflash LFA 447 xenon flash apparatus (Netzsch Group). The reference standard was pyroceram of similar thickness. Measurements are provided in units of κ (W/mK). The measurement determines the thermal diffusivity (α, cm²/s) and the specific heat (Cp, J/gK) of the sample, together with the density (ρ, g/cm³). Density was determined using a water immersion method (ASTM D792). The product of three values (α, ρ, and Cp) gives the thermal conductivity in the through plane according to:

κ=α(T)×Cp(T)×ρ(T).

TABLE 1

| Component | Chemical description | Source |
|---|---|---|
| PC1 | Copolymer of sebacic acid - BPA comprising | SABIC Innovative |
| | about 8.5 mol % sebacic acid with a Mw of about | Plastics (“SABIC |
| | 70,000 Daltons. | I.P.”) |
| PCPS1 | BPA polycarbonate-polydimethylsiloxane block | SABIC I.P. |
| | copolymer comprising about 20 wt % of siloxane | |
| | and about 80 wt % by of BPA; PCP end-capped; | |
| | with a polydiorgano-siloxane chain length of | |
| | about 45 and having a Mw of about 29,900 | |
| | Daltons. | |
| PCR | THPE branched polycarbonate resin made by the | SABIC I.P. |
| | interfacial process with an average Mw of about | |
| | 37,700 Daltons. | |
| T1 | Talc GH7(05), D50-5.8 μM, non-coating | Hayashi Kasei Co., |
| | | Ltd. |
| TO2 | TiO₂ (Type II per ASTM D476) with surface | Kronos, Inc. |
| | treatment comprising alumina and polysiloxane; | |
| | available under the trade name K2233, D50 = | |
| | 300 nm. | |

The materials used for preparing the formulations described herein are listed in Table 1 above. The formulations were prepared using a Twin screw extruder (Toshiba TEM-37BS, L/D=40.5) with the temperature of the extruder barrel set at 260° C. Pellets extruded from extruder were then injection molded into 80×10×3 mm bar, cut into 10×10×3 mm square sample for through plane TC measurement, Φ100×0.4 mm sheet and cut into Φ25×0.4 mm round sample for in plane TC measurement.

Exemplary formulations #1-6 are shown in Table 2, using the materials shown in Table 1. Molded samples were prepared using these formulations and characterized by various tests described herein above with the results shown in Table 3. All of the formulations contain the same thermally conductive fillers and filler loading. Formulation 1 only contains a high Mw PC. Formulations 2 and 3 contain 10 wt % polycarbonate-polysiloxane copolymer and branched PC, respectively. Addition of either 10 wt % EXL-PC (Formulation 2) or 10 wt % branched PC (Formulation 3) led to modest improvements in notched impact strength and tensile elongation compared to Formulation 1. Formulation 4 contains 10 wt % of both polycarbonate-polysiloxane copolymer and branched PC. Significant improvements in notched impact strength, unnotched impact strength, and tensile elongation were observed upon addition of 10 wt % of both EXL-PC and branched PC (Formulation 4). Additional increases in polymer loading (Formulations 5 and 6) did not lead to further increases in notched impact strength. Formulation 4 also offered an increase in Mw compared to Formulations 2 and 3.

TABLE 2

| Item Description | Unit | 1 | 2 | 3 | 4 | 5 | 6 |
|---|---|---|---|---|---|---|---|
| PC1 | % | 70 | 60 | 60 | 50 | 35 | 35 |
| PCPS1 | % | — | 10 | — | 10 | 15 | 15 |
| PCR | % | — | — | 10 | 10 | 20 | 20 |
| T1 | % | 10 | 10 | 10 | 10 | 10 | 10 |
| TO2 | % | 20 | 20 | 20 | 20 | 20 | 20 |
| Formulation Total | | 100 | 100 | 100 | 100 | 100 | 100 |

TABLE 3

| Test Description | Unit | 1 | 2 | 3 | 4 | 5 | 6 |
|---|---|---|---|---|---|---|---|
| Notched Izod | J/m | 50.6 | 121 | 61.4 | 513 | 255 | 245 |
| Impact Strength at | | | | | | | |
| r.t. - Avg | | | | | | | |
| Unnotched Izod | J/m | 1520 | 1290 | 1640 | 2160 | 1850 | 1570 |
| Impact Strength at | | | | | | | |
| r.t. - Avg | | | | | | | |
| Density-Avg | — | 1.470 | 1.464 | 1.465 | 1.464 | 1.462 | 1.475 |
| t/p Thermal | W/(m · K) | 0.45 | 0.45 | 0.44 | 0.49 | 0.54 | 0.45 |
| conductivity | | | | | | | |
| In plane Thermal | W/(m · K) | 1.49 | 2.03 | 2.12 | 1.57 | 1.53 | 1.71 |
| conductivity | | | | | | | |
| Modulus of | MPa | 3982.4 | 3029 | 3747 | 3098.2 | 2950 | 2950.6 |
| Elasticity-Avg | | | | | | | |
| Stress at Break- | MPa | 49.8 | 36.8 | 45 | 35.1 | 36.8 | 33.2 |
| Avg | | | | | | | |
| Elongation at | % | 4.57 | 9.49 | 6.37 | 11.98 | 10.88 | 9.97 |
| Break-Avg | | | | | | | |
| Mw | Daltons | 51808 | 58010 | 57147 | 63312 | 61598 | 61552 |
| Mn | Daltons | 19495 | 21157 | 20495 | 22590 | 21155 | 21104 |
| D | — | 2.66 | 2.74 | 2.79 | 2.8 | 2.91 | 2.92 |

Exemplary formulations #7-11 are shown in Table 4, using the materials shown in Table 1. Molded samples were prepared using these formulations and characterized by various tests described herein above with the results shown in Table 5. The effect of using polycarbonate-polysiloxane copolymer is shown in Table 5. In formulations 7-11 the thermally conductive filler loading was increased to 20 wt %. Formulation 7 is the control sample, with only the HFD-PC. Formulations 8 and 9 also contain 15 wt % polycarbonate-polysiloxane copolymer and formulation 10 also contains 15 wt % branched PC. The results indicate that notched impact strength and tensile elongation were improved in Formulations 8-10 compared to Formulation 7. Significant improvements in notched impact strength and tensile elongation were observed upon addition of 10 wt % of both polycarbonate-polysiloxane copolymer and branched PC (Formulation 11). Formulation 11 also offered an increase in Mw compared to Formulations 8-10. Thermal conductivity was only minimally reduced from 0.64 to 0.50 W/(m·K) (through plane) and from 2 to 1.6 W/(m·K) (in plane) (Formulation 11).

TABLE 4

| Item Description | Unit | 7 | 8 | 9 | 10 | 11 |
|---|---|---|---|---|---|---|
| PC1 | % | 60 | 45 | 45 | 45 | 40 |
| PCPS1 | % | — | 15 | 15 | — | 10 |
| PCR | % | — | — | — | 15 | 10 |
| T1 | % | 20 | 20 | 20 | 20 | 20 |
| TO2 | % | 20 | 20 | 20 | 20 | 20 |
| Formulation Total | | 100 | 100 | 100 | 100 | 100 |

TABLE 5

| Test Description | Unit | 7 | 8 | 9 | 10 | 11 |
|---|---|---|---|---|---|---|
| Notched Izod | J/m | 36.8 | 49.8 | 49.2 | 41.5 | 108 |
| Impact Strength at | | | | | | |
| r.t. - Avg | | | | | | |
| Unnotched Izod | J/m | 357 | 389 | 293 | 380 | 360 |
| Impact Strength at | | | | | | |
| r.t. - Avg | | | | | | |
| Density-Avg | — | 1.577 | 1.558 | 1.563 | 1.581 | 1.586 |
| t/p Thermal | W/(m · K) | 0.64 | 0.58 | 0.58 | 0.69 | 0.50 |
| conductivity | | | | | | |
| In plane Thermal | W/(m · K) | 2.00 | 1.67 | 1.50 | 2.11 | 1.60 |
| conductivity | | | | | | |
| Modulus of | MPa | 5671.8 | 4100 | 4170 | 5768 | 4302.2 |
| Elasticity-Avg | | | | | | |
| Stress at Break- | MPa | 60.3 | 45.6 | 45.5 | 61.2 | 43.7 |
| Avg | | | | | | |
| Elongation at | % | 1.97 | 2.2 | 2.09 | 2.09 | 2.45 |
| Break-Avg | | | | | | |
| Mw | Daltons | 48985 | 49088 | 50925 | 20392 | 26785 |
| Mn | Daltons | 18949 | 18392 | 18964 | 18146 | 20124 |
| D | — | 2.59 | 2.67 | 2.69 | 2.78 | 2.82 |

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A blended thermoplastic composition comprising:
a. from about 20 wt % to about 80 wt % of a first polycarbonate polymer component;
b. from about 1 wt % to about 30 wt % of a second polycarbonate polymer component, wherein the second polycarbonate polymer component is a branched chain polycarbonate polymer;
c. from about 1 wt % to about 30 wt % of at least one polycarbonate-polysiloxane copolymer component; and
d. from greater than 0 wt % to about 50 wt % of a thermally conductive filler component;
wherein the combined weight percent value of all components does not exceed about 100 wt %;
wherein all weight percent values are based on the total weight of the composition;
wherein a molded sample of the blended thermoplastic composition has a through-plane thermal conductivity when determined in accordance with ASTM E1461 of greater than or equal to about 0.4 W/mK; and
wherein a molded sample of the blended thermoplastic composition has an in-plane thermal conductivity when determined in accordance with ASTM E1461 of greater than or equal to about 1.0 W/mK.

2. The composition of claim 1, wherein the first polycarbonate polymer component is a copolymer.

3. The composition of claim 2, wherein the copolymer comprises repeating units derived from BPA.

4. The composition of claim 2, wherein the copolymer comprises repeating units derived from sebacic acid.

5. The composition of claim 2, wherein the copolymer comprises repeating units derived from sebacic acid and BPA.

6. The composition of claim 1, wherein the first polycarbonate polymer component has a weight average molecular weight from about 15,000 to about 75,000 grams/mole, as measured by gel permeation chromatography using BPA polycarbonate standards.

7. The composition of claim 1, wherein the first polycarbonate polymer component is present in an amount from about 35 wt % to about 70 wt %.

8. The composition of claim 1, wherein the first polycarbonate polymer component is present in an amount from about 45 wt % to about 60 wt %.

9. The composition of claim 1, wherein the second polycarbonate polymer component comprises residues derived from tris-(hydroxyphenyl)ethane.

10. The composition of claim 1, wherein the second polycarbonate polymer component is end-capped with p-hydroxybenzonitrile.

11. The composition of claim 1, wherein the second polycarbonate polymer component comprises residues derived from BPA.

12. The composition of claim 1, wherein the second polycarbonate polymer component is present in an amount from about 10 wt % to about 20 wt %.

13. The composition of claim 1, wherein the polycarbonate-polysiloxane copolymer component is a polycarbonate-polysiloxane block copolymer.

14. The composition of claim 13, wherein the polycarbonate block comprises residues derived from BPA.

15. The composition of claim 1, wherein the polycarbonate-polysiloxane copolymer component comprises dimethylsiloxane repeating units.

16. The composition of claim 1, wherein the polycarbonate-polysiloxane copolymer component comprises a polysiloxane block from about 15 wt % to about 25 wt % of the polycarbonate-polysiloxane copolymer component.

17. The composition of claim 1, wherein the polycarbonate-polysiloxane copolymer component is present in an amount from about 5 wt % to about 20 wt %.

18. The composition of claim 1, wherein the thermally conductive filler is selected from AlN, Al₄C₃, Al₂O₃, BN, AlON, MgSiN₂, SiC, Si₃N₄, graphite, expanded graphite, graphene, carbon fiber, ZnS, CaO, MgO, ZnO, TiO₂, H₂Mg₃(SiO₃)₄, CaCO₃, Mg(OH)₂, mica, BaO, γ-AlO(OH), α-AlO(OH), Al(OH)₃, BaSO₄, CaSiO₃, ZrO₂, SiO₂, a glass bead, a glass fiber, MgO.xAl₂O₃, CaMg(CO₃)₂, and a clay, or a combinations thereof.

19. The composition of claim 1, wherein the thermally conductive filler component is present in an amount from about 20 wt % to about 40% wt %.

20. The composition of claim 1, wherein the thermally conductive filler component comprises at least one intermediate thermally conductive filler and at least one low thermally conductive filler; wherein the intermediate thermally conductive filler component has a conductivity from about 10 W/mK to about 30 W/mK when determined in accordance with ASTM E1225; wherein the intermediate thermally conductive filler component is present in an amount from greater than 0 wt % to about 30 wt %; wherein the low thermally conductive filler component has a conductivity less than about 10 W/mK when determined in accordance with ASTM E1225; and wherein the low thermally conductive filler component is present in an amount from greater than 0 wt % to about 30 wt %.

21. The composition of claim 20, wherein the thermally conductive filler component comprising at least one intermediate thermally conductive filler present in an amount from about 15 wt % to about 25% wt %. and at least one low thermally conductive filler is present in an amount from about 10 wt % to about 20% wt %.

22. The composition of claim 1, further comprising a reinforcing component.

23. The composition of claim 22, wherein the reinforcing component is selected from glass beads, glass fiber, glass flakes, mica, talc, clay, wollastonite, zinc sulfide, zinc oxide, carbon fiber, ceramic-coated graphite, and titanium dioxide.

24. The composition of claim 22, wherein the reinforcing component is present in an amount from greater than 0 wt % to about 50 wt %.

25. The composition of claim 1, further comprising at least one flame retardant.

26. The composition of claim 25, wherein the flame retardant is a phosphorus-containing flame retardant.

27. The composition of claim 26, wherein the phosphorus-containing flame retardant is selected from a phosphine, a phosphine oxide, a bisphosphine, a phosphonium salt, a phosphinic acid salt, a phosphoric ester, and a phosphorous ester.

28. The composition of claim 26, wherein the phosphorus-containing flame retardant is an aromatic cyclic phosphazene compound.

29. The composition of any of claims 25, wherein the flame retardant is present in an amount less than or equal to about 20 wt %.

30. The composition of claim 1, further comprising at least one additive.

31. The composition of claim 30, wherein the additive is selected from an anti-drip agent, antioxidant, antistatic agent, chain extender, colorant, de-molding agent, dye, flow promoter, flow modifier, light stabilizer, lubricant, mold release agent, pigment, quenching agent, thermal stabilizer, UV absorbent substance, UV reflectant substance, and UV stabilizer, or combinations thereof.

32. An article comprising the composition of claim 1.

33. The article of claim 32, wherein the article is molded.

34. The article of claim 33, wherein the article is extrusion molded.

35. The article of claim 33, wherein the article is injection molded.

36. The article of claim 32, wherein the article is selected from a computer device, electromagnetic interference device, printed circuit, Wi-Fi device, Bluetooth device, GPS device, cellular antenna device, smart phone device, automotive device, medical device, sensor device, security device, shielding device, RF antenna device, LED device and RFID device.

37. The article of claim 36, wherein the LED device is a LED lamp.

38. The article of claim 32, wherein the article is selected from a RF antenna device, cellular antenna device, smart phone device, and electromagnetic interference device.

39. The article of claim 38, wherein the article is an external cover or frame for a RF antenna device, cellular antenna device, smart phone device, or electromagnetic interference device.

40. The article of claim 38, wherein the article is a central frame for a RF antenna device, cellular antenna device, smart phone device, or electromagnetic interference device.

41. A method of preparing a blended thermoplastic composition, comprising mixing:
a. from about 20 wt % to about 80 wt % of a first polycarbonate polymer component;
b. from about 1 wt % to about 30 wt % of a second polycarbonate polymer component, wherein the second polycarbonate polymer component is a branched chain polycarbonate polymer;
c. from about 1 wt % to about 30 wt % of at least one polycarbonate-polysiloxane copolymer component; and
d. from greater than 0 wt % to about 50 wt % of a thermally conductive filler component;
wherein the combined weight percent value of all components does not exceed about 100 wt %;
wherein all weight percent values are based on the total weight of the composition;
wherein a molded sample of the blended thermoplastic composition has a through-plane thermal conductivity when determined in accordance with ASTM E1461 of greater than or equal to about 0.4 W/mK; and
wherein a molded sample of the blended thermoplastic composition has an in-plane thermal conductivity when determined in accordance with ASTM E1461 of greater than or equal to about 1.0 W/mK.

42. The method of claim 41, wherein mixing comprises the steps of:
a. dry blending the following to form a polycarbonate dry blended mixture:
i. from 20 wt % to about 80 wt % of a first polycarbonate polymer component;
ii. from about 1 wt % to about 30 wt % of a second polycarbonate polymer component, wherein the second polycarbonate polymer component is a branched chain polycarbonate polymer; and
iii. from about 1 wt % to about 30 wt % of at least one polycarbonate-polysiloxane copolymer component;
b. feeding the polycarbonate dry blended mixture into an extruder apparatus; and
c. compounding in the extruder apparatus the polycarbonate dry blended mixture with from greater than 0 wt % to about 50 wt % of a thermally conductive filler component.

43. The method of claim 42, further comprising feeding into the extruder apparatus in a downstream extruder zone from about 25 wt % to about 60 wt % of a reinforcing filler.

44. A method of preparing a blended thermoplastic composition, comprising the steps:
a. dry blending the following to form a polycarbonate dry blended mixture:
i. from about 20 wt % to about 80 wt % of a first polycarbonate polymer component;
ii. from about 1 wt % to about 30 wt % of a second polycarbonate polymer component, wherein the second polycarbonate polymer component is a branched chain polycarbonate polymer; and
iii. from about 1 wt % to about 30 wt % of at least one polycarbonate-polysiloxane copolymer component;
b. feeding the polycarbonate dry blended mixture into an extruder apparatus; and
c. feeding into the extruder apparatus in a downstream extruder zone from greater than 0 wt % to about 50 wt % of a thermally conductive filler component;
wherein the combined weight percent value of all components does not exceed about 100 wt %;
wherein all weight percent values are based on the total weight of the composition;
wherein a molded sample of the blended thermoplastic composition has a through-plane thermal conductivity when determined in accordance with ASTM E1461 of greater than or equal to about 0.4 W/mK; and
wherein a molded sample of the blended thermoplastic composition has an in-plane thermal conductivity when determined in accordance with ASTM E1461 of greater than or equal to about 1.0 W/mK.

45. The method of claim 44, further comprising feeding into the extruder apparatus in a downstream extruder zone from greater than 0 wt % to about 50 wt % of a reinforcing component.

46. The method of claim 44, further comprising feeding into the extruder apparatus in a downstream extruder zone from greater than 0 wt % to about 20 wt % of a flame retardant.

47. The method of claim 44, further comprising feeding into the extruder apparatus in a downstream extruder zone from greater than 0 wt % to about 5 wt % of at least one additive.
